(19) United States
(12) Patent Application Publication
(10) Pub. No.: US 2024/0373476 A1
(43) Pub. Date: Nov. 7, 2024

(54) RANDOM ACCESS FOR ENHANCED REDUCED CAPABILITY USER EQUIPMENTS

(71) Applicant: Samsung Electronics Co., Ltd., Suwon-si (KR)

(72) Inventors: Anil Agiwal, Allen, TX (US); Shiyang Leng, Allen, TX (US); Kyeongin Jeong, Allen, TX (US)

(21) Appl. No.: 18/634,667

(22) Filed: Apr. 12, 2024

Related U.S. Application Data
(60) Provisional application No. 63/464,135, filed on May 4, 2023.

(51) Int. Cl. H04W 74/0838; H04L 1/08

(52) U.S. Cl. CPC H04W 74/0838; H04L 1/08

(57) ABSTRACT

A reduced capability (RedCap) user equipment (UE) includes a transceiver configured to receive a message including (i) one or more random access (RA) configurations and (ii) a contention free random access (CFRA) resource configuration including an indication of a number of message 1 (Msg1) repetitions. The RedCap UE further includes a processor operatively coupled to the transceiver. The Processor is configured to determine (i) whether a RA configuration, from the one or more RA configurations is associated with a RedCap feature, and (ii) whether the RA configuration is associated with the number of Msg1 repetitions included in the CFRA resource configuration, based on a result of the determination, select a first RA configuration, from the one or more RA configurations, and perform a RA procedure according to the selected first RA configuration.

### CROSS-REFERENCE TO RELATED APPLICATION AND CLAIM OF PRIORITY

This application claims priority under 35 U.S.C. § 119(e) to U.S. Provisional Patent Application No. 63/464,135 filed on May 4, 2023. The above-identified provisional patent application is hereby incorporated by reference in its entirety.

### TECHNICAL FIELD

This disclosure relates generally to wireless networks. More specifically, this disclosure relates to apparatuses and methods of random access for enhanced reduced capability user equipments.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. 5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods of random access for enhanced reduced capability user equipments.

In one embodiment, a reduced capability (RedCap) user equipment (UE) is provided. The RedCap UE includes a transceiver configured to receive a message including (i) one or more random access (RA) configurations and (ii) a contention free random access (CFRA) resource configuration including an indication of a number of message 1 (Msg1) repetitions. The RedCap UE further includes a processor operatively coupled to the transceiver. The Processor is configured to determine (i) whether a RA configuration, from the one or more RA configurations is associated with a RedCap feature, and (ii) whether the RA configuration is associated with the number of Msg1 repetitions included in the CFRA resource configuration, based on a result of the determination, select a first RA configuration, from the one or more RA configurations, and perform a RA procedure according to the selected first RA configuration.

In another embodiment, a base station (BS) is provided. The BS includes a transceiver configured to transmit a message including (i) one or more RA configurations and (ii) a CFRA resource configuration including an indication of a number of Msg1 repetitions. The BS further includes a processor operatively coupled to the transceiver. The processor is configured to perform a RA procedure with a RedCap UE. The RA procedure is performed according to a first RA configuration from the one or more RA configurations selected by the RedCap UE.

In yet another embodiment, a method of operating a RedCap UE is provided. The method includes receiving a message including (i) one or more RA configurations and (ii) a CFRA resource configuration including an indication of a number of Msg1 repetitions, and determining (i) whether a RA configuration, from the one or more RA configurations is associated with a RedCap feature, and (ii) whether the RA configuration is associated with the number of Msg1 repetitions included in the CFRA resource configuration. The method further includes, based on a result of the determination, selecting a first RA configuration, from the one or more RA configurations, and performing a RA procedure according to the selected first RA configuration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates a method for RAR/MsgB Handling for an eRedcap UE according to embodiments of the present disclosure;

FIG. 5 illustrates another method for RAR/MsgB Handling for an eRedcap UE according to embodiments of the present disclosure;

FIG. 6 illustrates another method for RAR/MsgB Handling for an eRedcap UE according to embodiments of the present disclosure;

FIG. 7 illustrates another method for RAR/MsgB Handling for an eRedcap UE according to embodiments of the present disclosure;

FIG. 8 illustrates a method for random access for early TA according to embodiments of the present disclosure; and

FIG. 9 illustrates a method for random access for enhanced reduced capability user equipments according to embodiments of the present disclosure.

### DETAILED DESCRIPTION

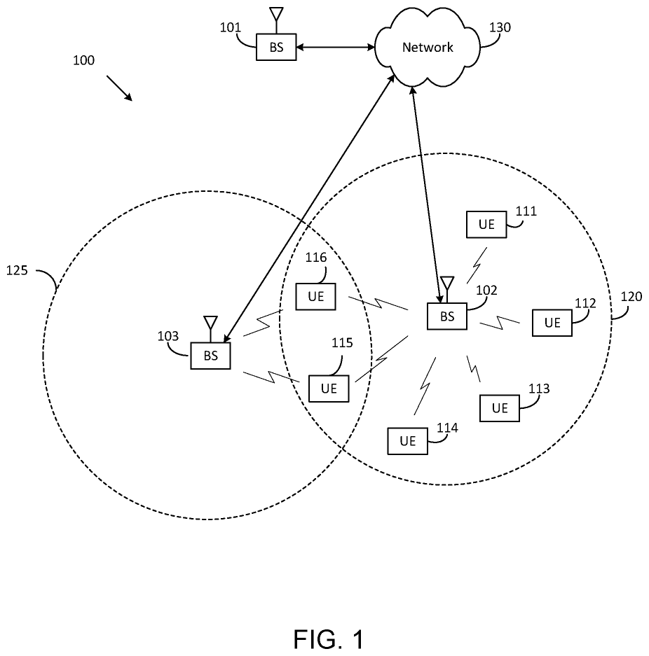

FIGS. 1 through 9, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for random access for enhanced reduced capability UEs. In certain embodiments, one or more of the gNBs 101-103 includes circuitry, programing, or a combination thereof, to support random access for enhanced reduced capability UEs in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

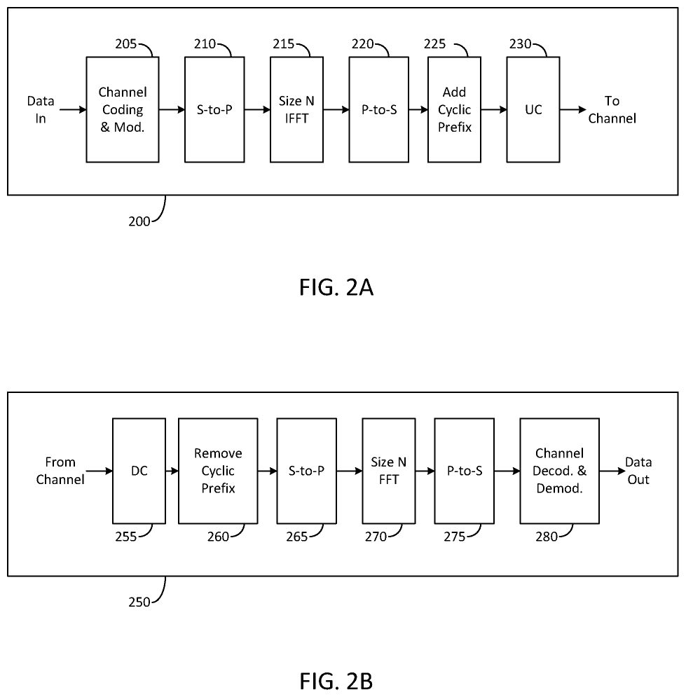

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

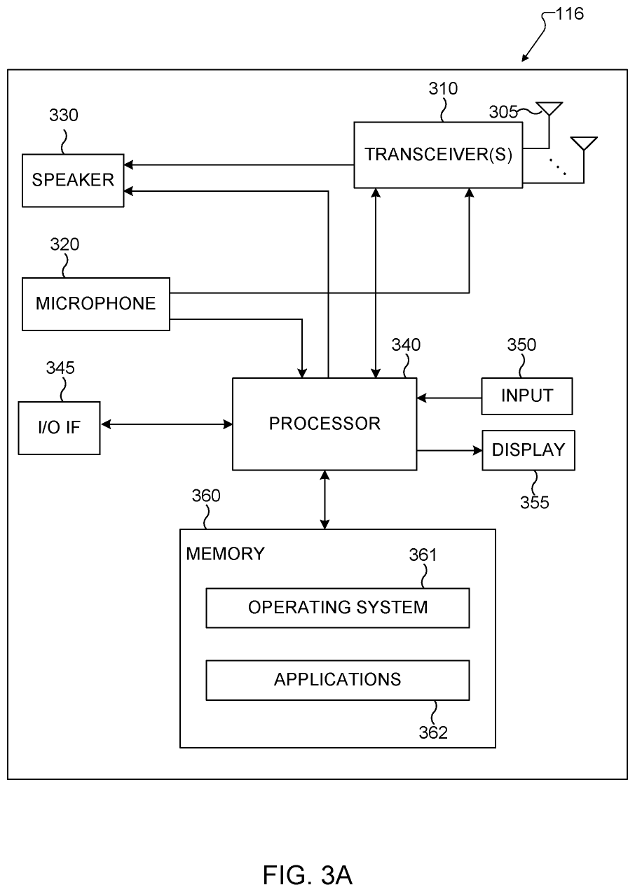

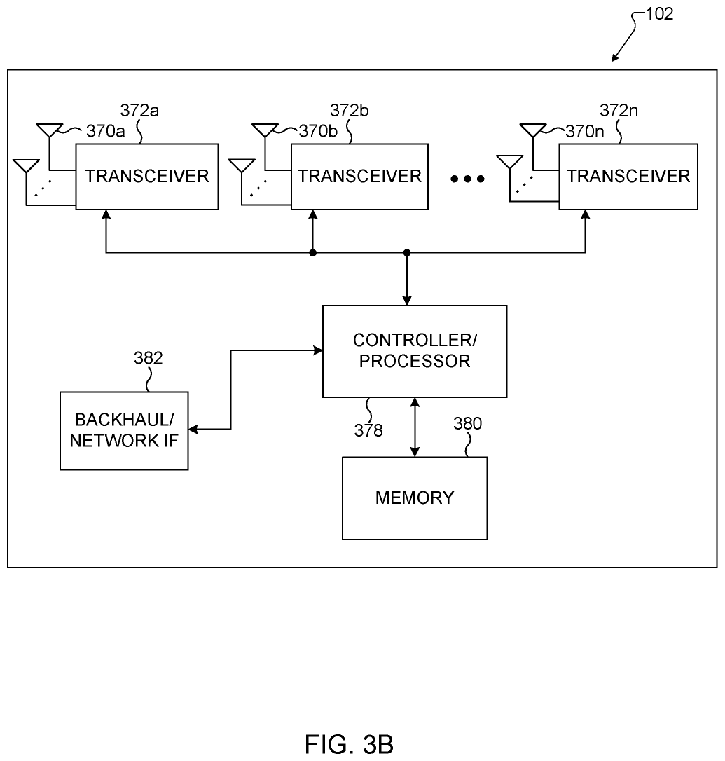

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for random access for enhanced reduced capability UEs as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support random access for enhanced reduced capability UEs as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the fifth-generation wireless communication system operating in higher frequency (mmWave) bands, the UE and gNB communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can transmit a plurality of transmit beam patterns in different directions. Each of these transmit beam patterns can also be referred to as a transmit (TX) beam. A wireless communication system operating at high frequency uses a plurality of narrow TX beams to transmit signals in the cell as each narrow TX beam provides coverage to a part of cell. The narrower the TX beam, higher the antenna gain and hence the larger the propagation distance of the signal transmitted using beamforming. A receiver can also receive a plurality of receive (RX) beam patterns of different directions. Each of these receive patterns can also be referred to as receive (RX) beam.

The fifth generation wireless communication system supports a standalone mode of operation as well as dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with CA/DC there is only one serving cell comprising the primary cell. For a UE in an RRC_CONNECTED state configured with CA/DC the term ‘serving cells’ is used to denote the set of cells comprising of the Special Cell(s) and all secondary cells. In NR the term Master Cell Group (MCG) refers to a group of serving cells associated with the Master Node, comprising the PCell and optionally one or more SCells. In NR the term Secondary Cell Group (SCG) refers to a group of serving cells associated with the Secondary Node, comprising the PSCell and optionally one or more SCells. In NR the term PCell (primary cell) refers to a serving cell in a MCG, operating on the primary frequency, in which the UE either performs the initial connection establishment procedure or initiates the connection re-establishment procedure. In NR for a UE configured with CA, an Scell is a cell providing additional radio resources on top of a Special Cell. A Primary SCG Cell (PSCell) refers to a serving cell in a SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

In the fifth generation wireless communication system, a node B (gNB) or base station in cell broadcast Synchronization Signal and PBCH block (SSB) comprises primary and secondary synchronization signals (PSS, SSS) and system information. System information includes common parameters used to communicate in a cell. In the fifth generation wireless communication system (also referred as next generation radio or NR), System Information (SI) is divided into the MIB and a number of SIBs where the MIB is always transmitted on the BCH with a periodicity of 80 ms and repetitions made within 80 ms and the MIB includes parameters that are used to acquire SIB1 from the cell. The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand, and, in that case, the configuration used by the UE to perform the SI request. SIB1 is a cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which comprises one or several cells and is identified by systemInformationAreaID; The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using the RRCReconfiguration message, e.g., if the UE has an active BWP with no common search space configured to monitor system information, paging, or upon request from the UE. In the RRC_CONNECTED state, the UE may acquire the required SIB(s) only from a PCell. For PSCell and SCells, the network provides the required SI by dedicated signaling, i.e., within an RRCReconfiguration message. Nevertheless, the UE shall acquire a MIB of the PSCell to get SFN timing of the SCG (which may be different from MCG). Upon change of relevant SI for the SCell, the network releases and adds the concerned SCell. For the PSCell, the required SI can only be changed with Reconfiguration with Sync.

In the fifth generation wireless communication system, a Physical Downlink Control Channel (PDCCH) is used to schedule DL transmissions on PDSCH and UL transmissions on PUSCH, where the Downlink Control Information (DCI) on PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, a PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random-access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCE. Different code rates for the control channels are realized by aggregating different number of CCEs. Interleaved and non-interleaved CCE-to-REG mapping are supported in a CORESET. Polar coding is used for PDCCH. Each resource element group carrying PDCCH carries its own DMRS. QPSK modulation is used for PDCCH.

In the fifth-generation wireless communication system, a list of search space configurations is signaled by the gNB for each configured BWP of the serving cell wherein each search configuration is uniquely identified by a search space identifier. The search space identifier is unique amongst the BWPs of a serving cell. An identifier of search space configuration to be used for a specific purpose such as paging reception, SI reception, or random access response reception is explicitly signaled by the gNB for each configured BWP. In NR search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0;

The starting symbol of a PDCCH monitoring occasion in each slot having a PDCCH monitoring occasion is given by the parameter Monitoring-symbols-PDCCH-within-slot. The length (in symbols) of a PDCCH monitoring occasion is given in the corset associated with the search space. The search space configuration includes the identifier of the CORESET configuration associated with it. A list of CORESET configurations are signaled by the gNB for each configured BWP of the serving cell wherein each CORESET configuration is uniquely identified by a CORESET identifier. The CORESET identifier is unique amongst the BWPs of a serving cell. Note that each radio frame is of 10 ms duration. The radio frame is identified by a radio frame number or system frame number. Each radio frame comprises several slots wherein the number of slots in a radio frame and the duration of the slots depends on sub carrier spacing (SCS). SCS is pre-defined in NR. Each CORESET configuration is associated with a list of transmission configuration indicator (TCI) states. One DL RS ID (SSB or CSI RS) is configured per TCI state. The list of TCI states corresponding to a CORESET configuration is signaled by the gNB via RRC signaling. One of the TCI states in the TCI state list is activated and indicated to the UE by the gNB. The TCI state indicates the DL TX beam (DL TX beam is QCLed with SSB/CSI RS of TCI state) used by the gNB for transmission of a PDCCH in the PDCCH monitoring occasions of a search space.

In the fifth-generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a bandwidth part (BWP). BA is achieved by configuring an RRC connected UE with BWP(s) and telling the UE which of the configured BWPs is currently the active one. When BA is configured, the UE only has to monitor PDCCH on the one active BWP. That is, it does not have to monitor PDCCH on the entire DL frequency of the serving cell. In the RRC connected state, the UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of random-access procedure. Upon addition of an SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of the BWP inactivity timer, the UE switches to the active DL BWP, to the default DL BWP, or initial DL BWP (if default DL BWP is not configured).

In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UEs in the RRC CONNECTED state. Several types of random-access procedures are supported.

One type of random-access procedure supported is contention based random access (CBRA). This is also referred as 4 step CBRA. In this type of random access, the UE first transmits a random access preamble (also referred to as Msg1) and then waits for random access response (RAR) in the RAR window. The RAR is also referred as Msg2. The next generation node B (gNB) transmits the RAR on a physical downlink shared channel (PDSCH). PDCCH scheduling the PDSCH carrying the RAR is addressed to a RA-radio network temporary identifier (RA-RNTI). The RA-RNTI identifies the time-frequency resource (also referred to as a physical RA channel [PRACH] occasion or PRACH transmission [TX] occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted the Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for the Msg1 transmission (0 for normal UL [NUL] carrier and 1 for supplementary UL [SUL] carrier). Several RARs for various random-access preambles detected by the gNB can be multiplexed in the same RAR media access control (MAC) protocol data unit (PDU) by the gNB. A RAR in a MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and the UE has not yet transmitted the RA preamble for a configurable (configured by the gNB in the RACH configuration) number of times, the UE goes back to the first step. That is, the UE selects a random access resource (preamble/RACH occasion) and transmits the RA preamble. A backoff may be applied before going back to first step.

If the RAR corresponding to its RA preamble transmission is received the UE transmits a message 3 (Msg3) in the UL grant received in the RAR. The Msg3 includes messages such as RRC connection request, RRC connection re-establishment request, RRC handover confirm, scheduling request, SI request etc. The Msg3 may include the LIE identity (i.e., cell-radio network temporary identifier (C-RNTI) or system architecture evolution (SAE)-temporary mobile subscriber identity (S-TMSI) or a random number). After transmitting the Msg3, the LIE starts a contention resolution timer. While the contention resolution timer is running, if the LIE receives a physical downlink control channel (PDCCH) addressed to a C-RNTI included in the Msg3, contention resolution is considered successful, the contention resolution timer is stopped, and the RA procedure is completed. While the contention resolution timer is running, if the LIE receives a contention resolution MAC control element (CE) including the UE's contention resolution identity (first X bits of common control channel [CCCH] service data unit [SDU] transmitted in Msg3), contention resolution is considered successful, the contention resolution timer is stopped, and the RA procedure is completed. If the contention resolution timer expires and the LIE has not yet transmitted the RA preamble for a configurable number of times, the LIE goes back to the first step. That is, the LIE selects a random access resource (preamble/RACH occasion) and transmits the RA preamble. A backoff may be applied before going back to first step.

Another type of random-access procedure supported is contention free random access (CFRA). This is also referred as legacy CFRA or 4 step CFRA. The CFRA procedure is used for scenarios such as handover where low latency is required, timing advance establishment for a secondary cell (Scell), etc. An Evolved node B (eNB) assigns to the LIE a dedicated Random access preamble. The LIE transmits the dedicated RA preamble. The eNB transmits the RAR on a PDSCH addressed to an RA-RNTI. The RAR conveys the RA preamble identifier and timing alignment (TA) information. The RAR may also include an UL grant. The RAR is transmitted in a RAR window similar to the contention-based RA (CBRA) procedure. The CFRA is considered successfully completed after receiving the RAR including the RA preamble identifier (RAPID) of the RA preamble transmitted by the LIE. In case the RA is initiated for beam failure recovery, CFRA is considered successfully completed if a PDCCH addressed to the C-RNTI is received in the search space for beam failure recovery. If the RAR window expires and the RA is not successfully completed and the UE has not yet transmitted the RA preamble for a configurable (configured by gNB in RACH configuration) number of times, the UE retransmits the RA preamble.

For certain events such has handover and beam failure recovery, if dedicated preamble(s) are assigned to UE, during first step of random access (i.e., during random access resource selection for Msg1 transmission) the UE determines whether to transmit a dedicated preamble or non-dedicated preamble. Dedicated preambles are typically provided for a subset of SSBs/CSI RSs. If there is no SSB/CSI RS having a DL RSRP above a threshold amongst the SSBs/CSI RSs for which contention free random access resources (i.e., dedicated preambles/ROs) are provided by the gNB, the UE selects a non-dedicated preamble. Otherwise, the UE selects a dedicated preamble. So, during the RA procedure, one random access attempt can be CFRA while other random access attempt can be CBRA.

Another type of random-access procedure supported is 2 step contention based random access (2 step CBRA). For 2 step CBRA, in the first step, the UE transmits a random access preamble on a PRACH and a payload (i.e., MAC PDU) on a PUSCH. The random access preamble and payload transmission is also referred as MsgA. In the second step, after MsgA transmission, the UE monitors for a response from the network (i.e., gNB) within a configured window. The response is also referred to as MsgB. A next generation node B (gNB) transmits the MsgB on a physical downlink shared channel (PDSCH). A PDCCH scheduling the PDSCH carrying MsgB is addressed to a MsgB-radio network temporary identifier (MSGB-RNTI). The MSGB-RNTI identifies the time-frequency resource (also referred as a physical RA channel [PRACH] occasion or PRACH transmission [TX] occasion or RA channel [RACH] occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted the Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL [NUL] carrier and 1 for supplementary UL [SUL] carrier).

If CCCH SDU was transmitted in the MsgA payload, the UE performs contention resolution using the contention resolution information in MsgB. The contention resolution is successful if the contention resolution identity received in the MsgB matches the first 48 bits of CCCH SDU transmitted in the MsgA. If a C-RNTI was transmitted in the MsgA payload, the contention resolution is successful if the UE receives a PDCCH addressed to the C-RNTI. If contention resolution is successful, the random-access procedure is considered successfully completed. Instead of contention resolution information corresponding to the transmitted MsgA, MsgB may include fallback information corresponding to the random access preamble transmitted in the MsgA. If the fallback information is received, the UE transmits a Msg3 and performs contention resolution using Msg4 as in the CBRA procedure. If the contention resolution is successful, the random-access procedure is considered successfully completed. If the contention resolution fails upon fallback (i.e., upon transmitting the Msg3), the UE retransmits the MsgA. If the configured window in which the UE monitors the network response after transmitting the MsgA expires and the UE has not received a MsgB including contention resolution information or fallback information as explained above, the UE retransmits the MsgA. If the random-access procedure is not successfully completed even after transmitting the MsgA a configurable number of times, the UE falls back to a 4 step RACH procedure. That is, the UE only transmits the PRACH preamble.

The MsgA payload may include one or more of a common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. The MsgA may include a UE ID (e.g., random ID, S-TMSI, C-RNTI, resume ID, etc.) along with the preamble in first step. The UE ID may be included in the MAC PDU of the MsgA. A UE ID such as C-RNTI may be carried in the MAC CE wherein the MAC CE is included in the MAC PDU. Other UE IDs (such as random ID, S-TMSI, C-RNTI, resume ID, etc.) may be carried in a CCCH SDU. The UE ID can be one of a random ID, S-TMSI, C-RNTI, resume ID, IMSI, idle mode ID, inactive mode ID, etc. The UE ID can be different in different scenarios in which the UE performs the RA procedure. When the UE performs RA after power on (before it is attached to the network), then the UE ID is the random ID. When the UE performs RA in an IDLE state after the UE is attached to network, the UE ID is the S-TMSI. If the UE has an assigned C-RNTI (e.g., in a connected state), the UE ID is the C-RNTI. In case the UE is in an INACTIVE state, the UE ID is the resume ID. In addition to the UE ID, some addition control information can be sent in the MsgA. The control information may be included in the MAC PDU of the MsgA. The control information may include one or more of a connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

Another type of random-access procedure supported is 2 step contention free random access (2 step CFRA). In 2 step CFRA the gNB assigns to the UE dedicated Random access preamble(s) and PUSCH resource(s) for MsgA transmission. RO(s) to be used for preamble transmission may also be indicated. In the first step, the UE transmits a random access preamble on a PRACH and a payload on a PUSCH using the contention free random access resources (i.e., dedicated preamble/PUSCH resource/RO). In the second step, after MsgA transmission, the UE monitors for a response from the network (i.e., gNB) within a configured window. The response is also referred as MsgB.

A next generation node B (gNB) transmits the MsgB on a physical downlink shared channel (PDSCH). A PDCCH scheduling the PDSCH carrying the MsgB is addressed to a MsgB-radio network temporary identifier (MSGB-RNTI). The MSGB-RNTI identifies the time-frequency resource (also referred as physical RA channel [PRACH] occasion or PRACH transmission [TX] occasion or RA channel [RACH] occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted the Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for the Msg1 transmission (0 for normal UL [NUL] carrier and 1 for supplementary UL [SUL] carrier).

If the UE receives a PDCCH addressed to the C-RNTI, the random-access procedure is considered successfully completed. If the UE receives fallback information corresponding to its transmitted preamble, the random-access procedure is considered successfully completed.

For certain events such has handover and beam failure recovery if dedicated preamble(s) and PUSCH resource(s) are assigned to UE, during first step of random access (i.e., during random access resource selection for MsgA transmission) the UE determines whether to transmit a dedicated preamble or a non-dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e., dedicated preambles/ROs/PUSCH resources) are provided by the gNB, the UE selects a non-dedicated preamble. Otherwise, the UE selects a dedicated preamble. During the RA procedure, one random access attempt can be 2 step CFRA while another random access attempt can be 2 step CBRA.

Upon initiation of a random-access procedure, the UE first selects the carrier (SUL or NUL). If the carrier to use for the random-access procedure is explicitly signaled by the gNB, the UE selects the signaled carrier for performing the random-access procedure. If the carrier to use for the aandom access procedure is not explicitly signaled by the gNB, and if the Serving Cell for the random-access procedure is configured with a supplementary uplink, and if the RSRP of the downlink pathloss reference is less than rsrp-ThresholdSSB-SUL, the UE selects the SUL carrier for performing the random-access procedure. Otherwise, the UE selects the NUL carrier for performing the random-access procedure. Upon selecting the UL carrier, the UE determines the UL and DL BWP for thee random-access procedure. The UE then determines whether to perform 2 step or 4 step RACH for this random-access procedure as follows:
If this random-access procedure is initiated by a PDCCH order and if the ra-PreambleIndex explicitly provided by PDCCH is not 0b000000, the UE selects 4 step RACH.
Otherwise, if 2 step contention free random access resources are signaled by the gNB for this random-access procedure, the UE selects 2 step RACH.
Otherwise, if 4 step contention free random access resources are signaled by the gNB for this random-access procedure, the UE selects 4 step RACH.
Otherwise, if the UL BWP selected for this random-access procedure is configured with only 2 step RACH resources, the UE selects 2 step RACH.
Otherwise, if the UL BWP selected for this random-access procedure is configured with only 4 step RACH resources, the UE selects 4 step RACH.
Otherwise, if the UL BWP selected for this random-access procedure is configured with both 2 step and 4 step RACH resources, if the RSRP of the downlink pathloss reference is below a configured threshold, the UE selects 4 step RACH.
Otherwise, UE selects 2 step RACH.

In fifth generation wireless communication system UEs with reduced capabilities are supported. A UE with reduced capabilities may be referred to as a RedCap UE. A RedCap UE is a UE with following reduced capabilities:
The maximum bandwidth is 20 MHz for FR1 (i.e., frequency range of 410 MHz-7125 MHz), and is 100 MHz for FR2 (i.e., frequency range of 24250 MHz-52600 MHz). UE features and corresponding capabilities related to UE bandwidths wider than 20 MHz in FR1 or wider than 100 MHz in FR2 are not supported by RedCap UEs;
The maximum mandatory supported DRB (data radio bearer) number is 8;
The mandatory supported PDCP SN (packet data convergence protocol sequence number) length is 12 bits with 18 bits being optional;
The mandatory supported RLC AM SN length is 12 bits with 18 bits being optional;
For FR1, 1 DL MIMO layer if 1 Rx branch is supported, and 2 DL MIMO layers if 2 Rx branches are supported; for FR2, either 1 or 2 DL MIMO layers can be supported, while 2 Rx branches are always supported. For FR1 and FR2, UE features and corresponding capabilities related to more than 2 UE Rx branches or more than 2 DL MIMO layers, as well as UE features and capabilities related to more than 1 UE Tx branch, or more than 1 UL MIMO layer are not supported by RedCap UEs;
CA, MR-DC, DAPS, CPAC and IAB (i.e., the RedCap UE is not expected to act as IAB node) related UE features and corresponding capabilities are not supported by RedCap UEs. All other feature groups or components of the feature groups as captured in TR 38.822 (3GPP TR 38.822: ″NR; User Equipment (UE) feature list) as well as capabilities specified in this specification remain applicable for RedCap UEs the same as non-RedCap UEs, unless indicated otherwise.

An enhanced RedCap (eRedCap) UE is the UE with one or more of the following reduced capabilities in addition to reduced capability defined for RedCap UE.
(a) UE BB bandwidth reduction
   i. 5 MHz BB bandwidth only for PDSCH (for both unicast and broadcast) and PUSCH, with 20 MHz RF bandwidth for UL and DL
   ii. The other physical channels and signals are still allowed to use a BWP up to the 20 MHz maximum UE RF+BB bandwidth.
(b) UE peak data rate reduction

In the fifth-generation wireless communication system, for UL coverage enhancements, repetitions of PRACH transmissions within a single random-access attempt (or PRACH attempt) is considered. For multiple PRACH transmissions within one RACH attempt, the PRACH transmissions are only transmitted over ROs associated with the same SSB/CSI-RS. For multiple PRACH transmissions with same Tx beam in one RACH attempt, transmission power ramping is not applied within one RACH attempt. For multiple PRACH transmissions with same Tx beam, only one RAR window is supported for RAR monitoring for one RACH attempt. For multiple PRACH transmissions with same Tx beam, to differentiate the multiple PRACH transmissions with single PRACH transmission, multiple PRACH transmitted on separate ROs is supported. For multiple PRACH transmissions with same Tx beam, to differentiate the multiple PRACH transmissions with single PRACH transmission, multiple PRACH transmitted with separate preamble on shared ROs is supported. For multiple PRACH transmissions with same Tx beam, the gNB can configure one or multiple values for the number of multiple PRACH transmissions. If multiple values are configured, PRACH resources differentiation between multiple PRACH transmissions with different numbers of multiple PRACH transmissions is supported.

In the fifth-generation wireless communication system multiple RA resources/configuration are supported. The network can associate a set of RACH resources with feature(s) applicable to a random-access procedure, such as Network Slicing, RedCap, SDT, and NR coverage enhancement (i.e., msg3 repetitions). A set of RACH resources (also referred to as RA partition/RA configuration) associated with a feature is only valid for random-access procedures applicable to at least that feature. A set of RACH resources associated with several features is only valid for random-access procedures having at least all of these features. The UE selects the set(s) of applicable RACH resources, after uplink carrier (i.e., NUL or SUL) and BWP selection and before selecting the RA type.

If redCap is set to true for a set of random access resources, the UE considers the set of random access resources as not available for a random-access procedure for which RedCap is not applicable. If smallData is set to true for a set of random access resources, the UE considers the set of Random Access resources as not available for the random-access procedure which is not triggered for SDT. If NSAG-List is configured for a set of random access resources, the UE considers the set of random access resources as not available for the random-access procedure unless it is triggered for any one of the NSAG-ID(s) in the NSAG-List. If msg3-Repetitions is set to true for a set of random access resources, the UE considers the set of random access resources as not available for the random-access procedure if Msg3 repetition is not applicable. If a set of random access resources is not configured with FeatureCombination, the UE considers the set of random access resources to not associated with any feature.

If contention-free Random Access Resources have not been provided for a random-access procedure and one or more of the features including RedCap and/or Slicing and/or SDT and/or MSG3 repetition is applicable for this random-access procedure, if none of the sets of random access resources are available for any feature applicable to the current random-access procedure, the UE selects the set(s) of random access resources that are not associated with any feature indication for this random-access procedure. Otherwise, if there is one set of random access resources available which can be used for indicating all features triggering this random-access procedure, the UE selects this set of random access resources for this random-access procedure. Otherwise, (i.e., there are one or more sets of random access resources available that are configured with indication(s) for a subset of all features triggering this random-access procedure), the UE selects a set of random access resources from the available set(s) of random access resources based on the priority order of features for this random-access procedure.

Otherwise, if contention-free random access resources have been provided for this random-access procedure and RedCap is applicable for the current random-access procedure and there is one set of random access resources available that is only configured with RedCap indication, the selects this set of random access resources for this random-access procedure. Otherwise, the UE selects the set of random access resources that are not associated with any feature indication for the current random-access procedure.

The UE selects random access resource based on priority as follows: among the available sets of random access resources for this random-access procedure, the UE identifies those configured with a feature which has the highest priority assigned in featurePriorities (priority is assigned for each of features) among all the features applicable to this random-access procedure. If a single set of random access resources is identified, the UE selects this set of Random Access resources. Otherwise, if more than one set of random access resources is identified, the UE repeats the procedure taking as an input the identified sets of random access resources and the feature applicable to the current random-access procedure with the highest priority assigned in featurePriorities among all the features applicable to this random-access procedure, except the features considered already. Otherwise, (i.e., no set of random access resources is identified). The UE repeats the procedure taking as an input the previous identified available sets of random access resources and the feature applicable to the current random-access procedure with the highest priority assigned in featurePriorities among all the features applicable to this random-access procedure, except the features considered already.

For UE BB bandwidth reduction, for a RAR (PDSCH) to an eRedCap UE, the scheduling of the RAR PDSCH is allowed to be larger than the maximum number of unicast PRBs that the UE can process per slot. When the scheduling of the RAR PDSCH is within the maximum number of unicast PRBs that the UE can process per slot, the time between RAR reception and Msg3 transmission (not smaller than N_{T,1}+N_{T,2}+0.5 ms) is applied. When the scheduling of the RAR PDSCH is larger than the maximum number of unicast PRBs that the UE can process per slot, the UE receives the RAR and correspondingly transmits the Msg3 if the TDRA (time domain resource allocation) for the Msg3 in the UL grant in RAR indicates that the time between the RAR reception and the Msg3 transmission is NOT smaller than N_{T,1}+N_{T,2}+0.5+X ms. The Value of X is pre-defined. Otherwise, the UE behavior is up to the UE implementation.

When the scheduling of the RAR PDSCH is larger than the maximum number of unicast PRBs that the UE can process per slot and if the TDRA for the Msg3 in the UL grant in the RAR indicates that the time between the RAR reception and the Msg3 transmission is smaller than N_{T,1}+N_{T,2}+0.5+X ms, the UE cannot transmit Msg3.

In the abovementioned scenario, the UE has received a PDCCH addressed to an RA-RNTI and successfully decoded a TB that includes a MAC RAR corresponding to the RA preamble transmitted by UE. Therefore, as per the current procedure, RAR reception is considered successful. This has the consequence that the UE will get stuck in the random-access procedure, because a contention resolution timer is not started if a Msg3 is not transmitted, and an RA preamble is not transmitted as the RAR reception is considered successful. The present disclosure provides methods and apparatuses that overcome these issues.

In the fifth-generation wireless communication system multiple RA resources/configuration are supported. The network can associate a set of RACH resources with feature(s) applicable to a random-access procedure, such as Network Slicing, RedCap, SDT, and NR coverage enhancement (i.e., msg3 repetitions). A set of RACH resources (also referred to as RA partition/RA configuration) associated with a feature is only valid for random-access procedures applicable to at least that feature. Furthermore, a set of RACH resources associated with several features is only valid for random-access procedures having at least all of these features. The UE selects the set(s) of applicable RACH resources, after uplink carrier (i.e., NUL or SUL) and BWP selection and before selecting the RA type.

In fifth generation wireless communication system, for UL coverage enhancements, repetitions of PRACH transmissions within a single random-access attempt (or PRACH attempt) is considered. For multiple PRACH transmissions within one RACH attempt, the PRACH transmissions are only transmitted over ROs associated with the same SSB/CSI-RS. For multiple PRACH transmissions with the same Tx beam in one RACH attempt, transmission power ramping is not applied within one RACH attempt. For multiple PRACH transmissions with same Tx beam, only one RAR window is supported for RAR monitoring for one RACH attempt. For multiple PRACH transmissions with same Tx beam, to differentiate the multiple PRACH transmissions with single PRACH transmission, multiple PRACHs transmitted on separate ROs is supported. For multiple PRACH transmissions with the same Tx beam, to differentiate the multiple PRACH transmissions with single PRACH transmission, multiple PRACHs transmitted with separate preambles on shared ROs is supported. For multiple PRACH transmissions with the same Tx beam, the gNB can configure one or multiple values for the number of multiple PRACH transmissions. If multiple values are configured, PRACH resources differentiation between multiple PRACH transmissions with different number of multiple PRACH transmissions is supported.

According to current procedure for CFRA wherein CFRA resources are provided in a PDCCH order/Reconfiguration with sync/beam failure reconfiguration, If the UE is RedCap UE, the UE selects an RA resources/configuration associated with redcap only. If an RA resources/configuration associated with redcap only is not available, the UE selects an RA resources/configuration which is not associated with any feature. Otherwise, the UE selects an RA resources/configuration which is not associated with any feature.

In case msg1 repetitions is supported for CFRA, the above procedure will result in incorrect selection of an RA resources/configuration. The present disclosure provides methods and apparatuses that overcome these issues.

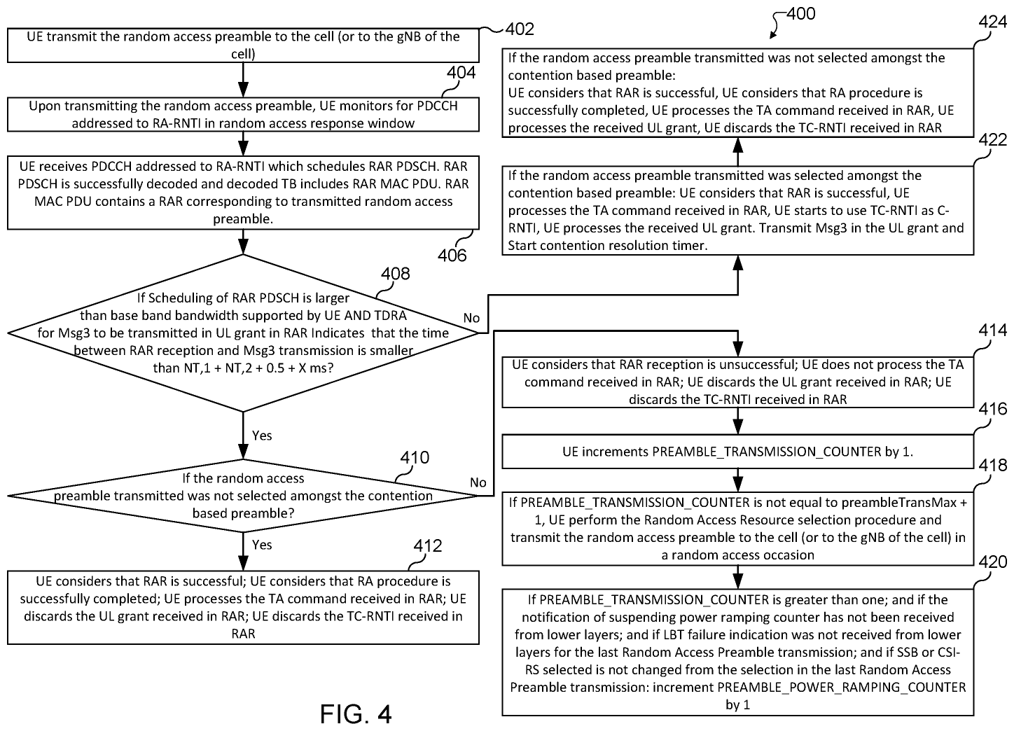

FIG. 4 illustrates a method 400 for RAR/MsgB Handling for an eRedcap UE according to embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments for RAR/MsgB Handling for an eRedcap UE could be used without departing from the scope of this disclosure.

In the example of FIG. 4, prior to the start of method 400, a UE such as UE 116 of FIG. 1 or a MAC entity in the UE initializes/sets to 1 PREAMBLE_TRANSMISSION_COUNTER and PREAMBLE_POWER_RAMPING_COUNTER when a random-access procedure is initiated towards a cell.

The method 400 begins at step 402. At step 402, the UE transmits a random access preamble to the cell (or to a gNB of the cell, such as BS) in a random access occasion. The random access preamble is transmitted on a physical random access channel (PRACH). At step 404, upon transmitting the random access preamble, the UE monitors for a PDCCH (physical downlink common control channel) addressed to an RA-RNTI in the random access response window. At step 406, the UE receives a PDCCH addressed to the RA-RNTI which schedules a RAR PDSCH. The RAR PDSCH is successfully decoded, and the decoded TB includes a RAR MAC PDU. The RAR MAC PDU contains a RAR corresponding to the transmitted random access preamble. The RAR MAC PDU contains a MAC subPDU with a Random Access Preamble identifier (in the MAC subPDU subheader/header) corresponding to the index/identifier of the transmitted random access preamble and this MAC subPDU is not a RAPID only MAC subPDU (i.e. it includes a payload which contains TA, TC-RNTI and UL grant). This MAC subPDU is also referred to as a MAC RAR.

At step 408, if the RAR PDSCH is scheduled over a bandwidth larger than the base band bandwidth supported by the UE (i.e., larger than the maximum number of PRBs that the UE can process per slot) and the TDRA for the Msg3 to be transmitted in the UL grant in the RAR indicates that the time between RAR reception and Msg3 transmission is smaller than N_{T,1}+N_{T,2}+0.5+X ms (where N_{T,1} is a time duration of N₁ symbols corresponding to a PDSCH processing time for UE processing capability 1 when additional PDSCH DM-RS is configured, N_{T,2} is a time duration of N₂ symbols corresponding to a PUSCH preparation time for UE processing capability 1 and, for determining the minimum time, the UE considers that N₁ and N₂ correspond to the smaller of the SCS configurations for the PDSCH and the PUSCH. For μ=0, the UE assumes N_{1,0}=14. The value of X can be configured or pre-defined), the method proceeds to step 410. Otherwise, the method proceeds to step 422.

At step 410, if the random access preamble transmitted was not selected amongst the contention based preambles (e.g., the random access preamble transmitted is a dedicated preamble assigned by the gNB to the UE), the method proceeds to step 412. Otherwise (if the random access preamble transmitted was selected amongst the contention based preambles), the method proceeds to step 414.

At step 412, the UE considers that random access response is successful; the UE considers that RA procedure is successfully completed; the UE processes the TA command received in MAC RAR; the UE discards the UL grant received in MAC RAR; and the UE discards the TC-RNTI received in MAC RAR.

At step 414, the UE considers that random access response reception is unsuccessful; the UE; the UE does not process the TA command received in MAC RAR; the UE discards the UL grant received in MAC RAR; and the UE discards the TC-RNTI received in MAC RAR.

At step 416, the UE increments PREAMBLE_TRANSMISSION_COUNTER by 1.

At step 418, if PREAMBLE_TRANSMISSION_COUNTER=preambleTransMax+1:
if the Random Access Preamble is transmitted on the SpCell:
   the UE indicates a random access problem to upper layers i.e., via RRC;
   if this random-access procedure was triggered for an SI request, the UE considers the random-access procedure unsuccessfully completed.
otherwise, if the random access preamble is transmitted on an SCell:
   the UE considers the random-access procedure unsuccessfully completed.
if the random-access procedure is not completed, the UE performs the Random Access Resource selection procedure and transmits the random access preamble to the cell (or to the gNB of the cell) in a random access occasion.

At step 420, if PREAMBLE_TRANSMISSION_COUNTER is greater than one, and if the notification of suspending power ramping counter has not been received from the lower layers, and if an LBT failure indication was not received from the lower layers for the last Random Access Preamble transmission, and if an SSB or CSI-RS selected is not changed from the selection in the last Random Access Preamble transmission, the UE increments PREAMBLE_POWER_RAMPTNG_COUNTER by 1.

At step 422, if the random access preamble transmitted was selected amongst the contention based preambles, the UE considers that random access response is successful; the UE processes the TA command received in MAC RAR; the UE starts to use TC-RNTI as C-RNTI; the UE processes the received UL grant in MAC RAR; and the UE transmits a Msg3 in the UL grant and starts the contention resolution timer.

At step 424, if the random access preamble transmitted was not selected amongst the contention based preambles, the UE considers that random access response is successful; the UE considers that RA procedure is successfully completed; the UE processes the TA command received in MAC RAR; the UE processes the received UL grant in MAC RAR; and the UE discards the TC-RNTI received in MAC RAR.

Although FIG. 4 illustrates one example of a method 400 for RAR/MsgB Handling for an eRedcap UE, various changes may be made to FIG. 4. For example, while shown as a series of steps, various steps in FIG. 4 could overlap, occur in parallel, occur in a different order, occur any number of times, be omitted, or replaced by other steps.

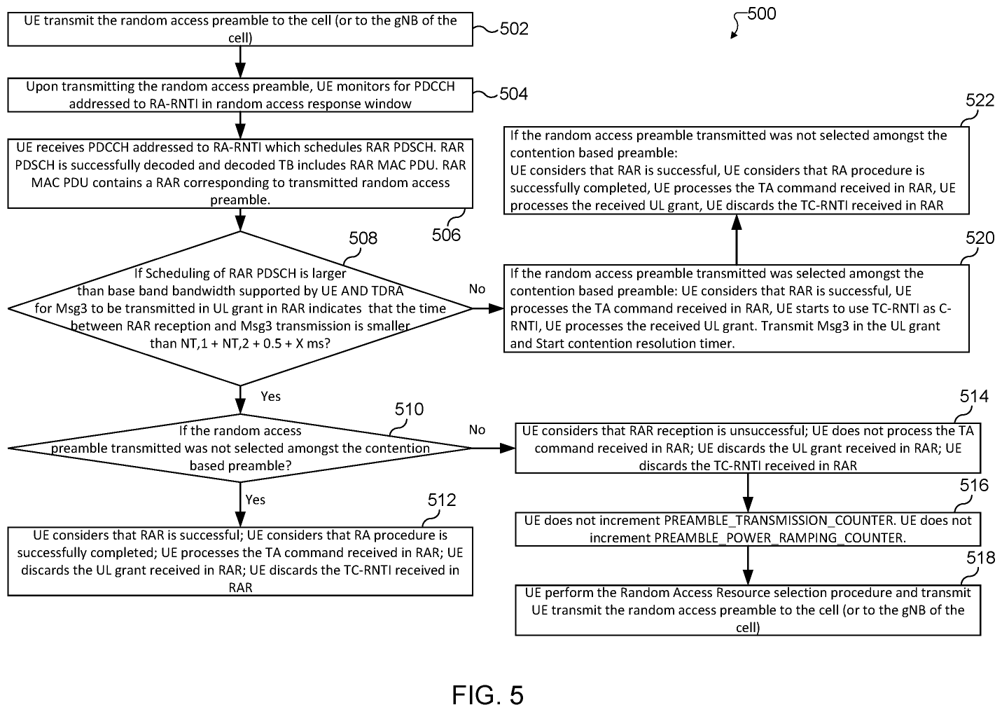

FIG. 5 illustrates another method 500 for RAR/MsgB Handling for an eRedcap UE according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for RAR/MsgB Handling for an eRedcap UE could be used without departing from the scope of this disclosure.

In the example of FIG. 5, prior to the start of method 500, a UE such as UE 116 of FIG. 1 or a MAC entity in the UE initializes/sets to 0 PREAMBLE_TRANSMISSION_COUNTER and PREAMBLE_POWER_RAMPING_COUNTER when a random-access procedure is initiated towards a cell.

The method 500 begins at step 502. At step 502, the UE transmits a random access preamble to the cell (or to a gNB of the cell, such as a BS) in a random access occasion. The random access preamble is transmitted on a physical random access channel (PRACH). At step 504, upon transmitting the random access preamble, the UE monitors for a PDCCH (physical downlink common control channel) addressed to an RA-RNTI in the random access response window. At step 506, the UE receives a PDCCH addressed to the RA-RNTI which schedules a RAR PDSCH. The RAR PDSCH is successfully decoded, and the decoded TB includes a RAR MAC PDU. The RAR MAC PDU contains a RAR corresponding to the transmitted random access preamble.

At step 508, if the RAR PDSCH is scheduled over a bandwidth larger than the base band bandwidth supported by the UE (i.e., larger than the maximum number of PRBs that the UE can process per slot) and the TDRA for the Msg3 to be transmitted in the UL grant in the RAR indicates that the time between RAR reception and Msg3 transmission is smaller than N_{T,1}+N_{T,2}+0.5+X ms (where N_{T,1} is a time duration of N₁ symbols corresponding to a PDSCH processing time for UE processing capability 1 when additional PDSCH DM-RS is configured, N_{T,2} is a time duration of N₂ symbols corresponding to a PUSCH preparation time for UE processing capability 1 and, for determining the minimum time, the UE considers that N₁ and N₂ correspond to the smaller of the SCS configurations for the PDSCH and the PUSCH. For μ=0, the UE assumes N_{1,0}=14. The value of X can be configured or pre-defined), the method proceeds to step 510. Otherwise, the method proceeds to step 522.

At step 510, if the random access preamble transmitted was not selected amongst the contention based preambles (e.g., the random access preamble transmitted is a dedicated preamble assigned by the gNB to the UE), the method proceeds to step 512. Otherwise (if the random access preamble transmitted was selected amongst the contention based preambles), the method proceeds to step 514.

At step 512, the UE considers that random access response is successful; the UE considers that RA procedure is successfully completed; the UE processes the TA command received in MAC RAR; the UE discards the UL grant received in MAC RAR; and the UE discards the TC-RNTI received in MAC RAR.

At step 514, the UE considers that random access response reception is unsuccessful; the UE; the UE does not process the TA command received in MAC RAR; the UE discards the UL grant received in MAC RAR; and the UE discards the TC-RNTI received in MAC RAR.

At step 516, in one embodiment, the UE may not increment PREAMBLE_TRANSMISSION_COUNTER, and the UE may not increment PREAMBLE_POWER_RAMPING_COUNTER. In one embodiment, the UE may increment PREAMBLE_POWER_RAMPING_COUNTER similar as described regarding FIG. 4.

At step 518, the UE performs the Random Access Resource selection procedure, and the UE transmits the random access preamble to the cell (or to the gNB of the cell) in a random access occasion. In one embodiment, the UE may ignore/discard the backoff indicator (if any) received in the RAR. In one embodiment, the UE may store the backoff indicator (if any) received in RAR and perform the random access preamble transmission after applying backoff.

At step 520, if the random access preamble transmitted was selected amongst the contention based preambles, the UE considers that random access response is successful; the UE processes the TA command received in MAC RAR; the UE starts to use TC-RNTI as C-RNTI; the UE processes the received UL grant in MAC RAR; and the UE transmits a Msg3 in the UL grant and starts the contention resolution timer.

At step 522, if the random access preamble transmitted was not selected amongst the contention based preambles, the UE considers that random access response is successful; the UE considers that RA procedure is successfully completed; the UE processes the TA command received in MAC RAR; the UE processes the received UL grant in MAC RAR; and the UE discards the TC-RNTI received in MAC RAR.

Although FIG. 5 illustrates one example of a method 500 for RAR/MsgB Handling for an eRedcap UE, various changes may be made to FIG. 5. For example, while shown as a series of steps, various steps in FIG. 5 could overlap, occur in parallel, occur in a different order, occur any number of times, be omitted, or replaced by other steps.

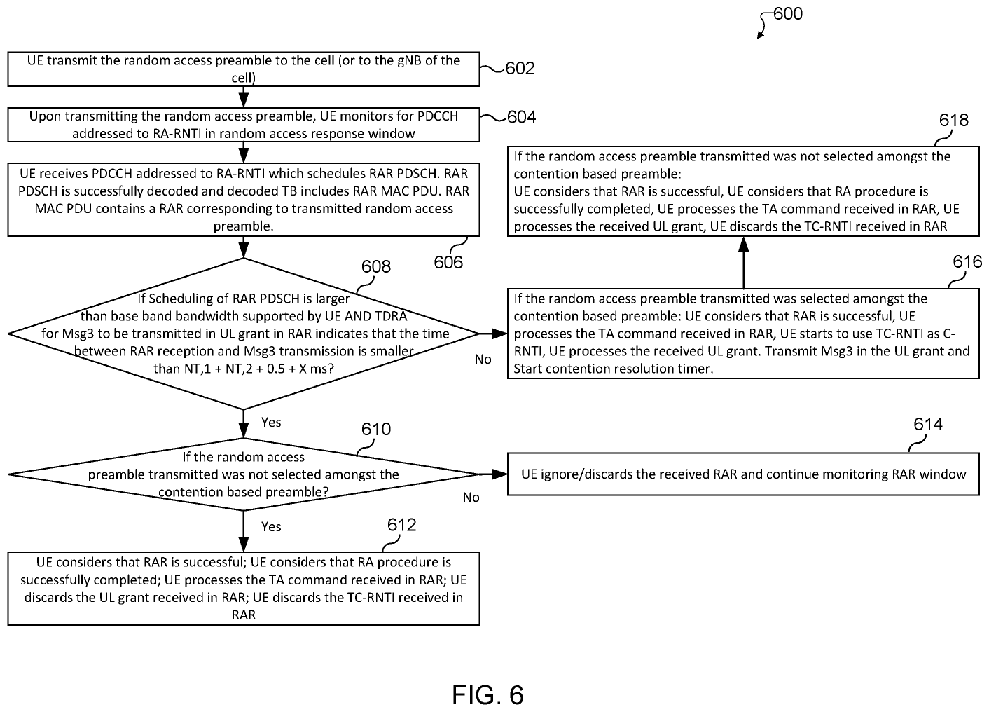

FIG. 6 illustrates another method 600 for RAR/MsgB Handling for an eRedcap UE according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments for RAR/MsgB Handling for an eRedcap UE could be used without departing from the scope of this disclosure.

In the example of FIG. 6, prior to the start of method 600, a UE such as UE 116 of FIG. 1 or a MAC entity in the UE initializes/sets to 1 PREAMBLE_TRANSMISSION_COUNTER and PREAMBLE_POWER_RAMPING_COUNTER when a random-access procedure is initiated towards a cell.

The method 600 begins at step 602. At step 602, the UE transmits a random access preamble to the cell (or to a gNB of the cell, such as a BS) in a random access occasion. The random access preamble is transmitted on a physical random access channel (PRACH). At step 604, upon transmitting the random access preamble, the UE monitors for a PDCCH (physical downlink common control channel) addressed to an RA-RNTI in the random access response window. At step 606, the UE receives a PDCCH addressed to RA-RNTI which schedules a PDSCH for a RAR. The PDSCH for the RAR is successfully decoded and the received transport block (TB) includes a RAR MAC PDU. The RAR MAC PDU contains a MAC subPDU with a Random Access Preamble identifier (in the MAC subPDU subheader/header) corresponding to the index/identifier of transmitted random access preamble and this MAC subPDU is not a RAPID only MAC subPDU (i.e., it includes a payload which contains TA, TC-RNTI and UL grant). This MAC subPDU is also referred as a MAC RAR.

At step 608, if Scheduling of the RAR PDSCH is larger than the base band bandwidth supported by the UE (i.e., larger than the maximum number of unicast PRBs that the UE can process per slot) AND the TDRA for Msg3 to be transmitted in the UL grant in the RAR indicates that the time between the RAR reception and Msg3 transmission is smaller than NT,1+NT,2+0.5+X ms (where N_{T,1} is a time duration of N₁ symbols corresponding to a PDSCH processing time for UE processing capability 1 when additional PDSCH DM-RS is configured, N_{T,2} is a time duration of N₂ symbols corresponding to a PUSCH preparation time for UE processing capability 1 and, for determining the minimum time, the UE considers that N₁ and N₂ correspond to the smaller of the SCS configurations for the PDSCH and the PUSCH. For μ=0, the UE assumes N_{1,0}=14. The value of X can be configured or pre-defined), the method proceeds to step 610. Otherwise, the method proceeds to step 616.

At step 610, if the random access preamble transmitted was not selected amongst the contention based preamble (e.g., it is a dedicated preamble assigned by the gNB to the UE), the method proceeds to step 612. Otherwise, the method proceeds to step 614.

At step 612 the UE considers that random access response is successful; the UE considers that RA procedure is successfully completed; the UE processes the TA command received in MAC RAR the UE discards the UL grant received in MAC RAR; and the UE discards the TC-RNTI received in MAC RAR.

At step 614 (if the random access preamble transmitted was selected amongst the contention based preambles), the UE ignore/discards the received RAR and continue monitoring RAR window. In an embodiment, UE may ignore/discard the backoff indicator (if any) received in RAR. In an alternate embodiment, UE may store the backoff indicator (if any) received in RAR and perform random access preamble transmission after applying backoff.

At step 616 (if Scheduling of the RAR PDSCH is not larger than the maximum number of unicast PRBs that the UE can process per slot OR the TDRA for the Msg3 to be transmitted in the UL grant in the RAR indicates that the time between the RAR reception and Msg3 transmission is not smaller than NT,1+NT,2+0.5+X ms), if the random access preamble transmitted was selected amongst the contention based preambles, the UE considers that random access response is successful; the UE processes the TA command received in the MAC RAR; the UE starts to use TC-RNTI as C-RNTI; the UE processes the received UL grant in the MAC RAR; and the UE Transmits a Msg3 in the UL grant and starts the contention resolution timer.

At step 618 if the random access preamble transmitted was not selected amongst the contention based preambles, the UE considers that random access response is successful; the UE considers that the RA procedure is successfully completed; the UE processes the TA command received in the MAC RAR; the UE processes the received UL grant in the MAC RAR; and the UE discards the TC-RNTI received in the MAC RAR

Although FIG. 6 illustrates one example of a method 600 for RAR/MsgB Handling for an eRedcap UE, various changes may be made to FIG. 6. For example, while shown as a series of steps, various steps in FIG. 6 could overlap, occur in parallel, occur in a different order, occur any number of times, be omitted, or replaced by other steps.

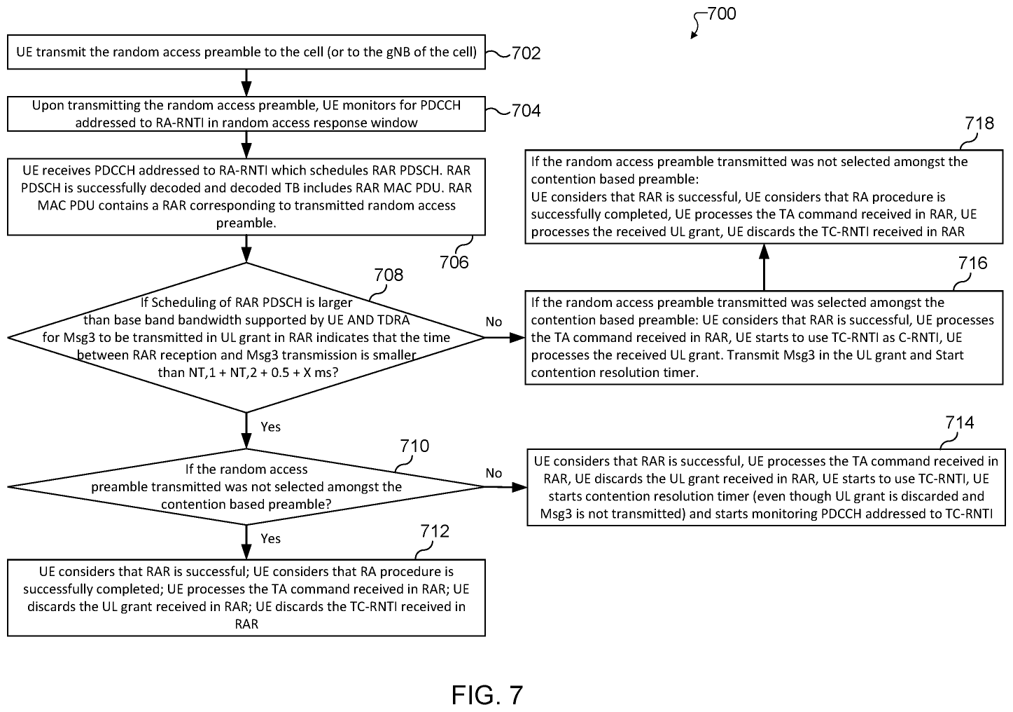

FIG. 7 illustrates another method 700 for RAR/MsgB Handling for an eRedcap UE according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for RAR/MsgB Handling for an eRedcap UE could be used without departing from the scope of this disclosure.

In the example of FIG. 7, prior to the start of method 700, a UE such as UE 116 of FIG. 1 or a MAC entity in the UE initializes/sets to 1 PREAMBLE_TRANSMISSION_COUNTER and PREAMBLE_POWER_RAMPING_COUNTER when a random-access procedure is initiated towards a cell.

The method 700 begins at step 702. At step 702, the UE transmits a random access preamble to the cell (or to a gNB of the cell, such as a BS) in a random access occasion. The random access preamble is transmitted on a physical random access channel (PRACH). At step 704, upon transmitting the random access preamble, the UE monitors for a PDCCH (physical downlink common control channel) addressed to an RA-RNTI in the random access response window. At step 706, the UE receives a PDCCH addressed to RA-RNTI which schedules a PDSCH for a RAR. The PDSCH for the RAR is successfully decoded and the received transport block (TB) includes a RAR MAC PDU. The RAR MAC PDU contains a MAC subPDU with a Random Access Preamble identifier (in the MAC subPDU subheader/header) corresponding to the index/identifier of transmitted random access preamble and this MAC subPDU is not a RAPID only MAC subPDU (i.e., it includes a payload which contains TA, TC-RNTI and UL grant). This MAC subPDU is also referred as a MAC RAR.

At step 708, if Scheduling of the RAR PDSCH is larger than the base band bandwidth supported by the UE (i.e., larger than the maximum number of unicast PRBs that the UE can process per slot) AND the TDRA for the Msg3 to be transmitted in the UL grant in the RAR indicates that the time between the RAR reception and Msg3 transmission is smaller than NT, 1+NT,2+0.5+X ms (where N_{T,1} is a time duration of N₁ symbols corresponding to a PDSCH processing time for UE processing capability 1 when additional PDSCH DM-RS is configured, N_{T,2} is a time duration of N₂ symbols corresponding to a PUSCH preparation time for UE processing capability 1 and, for determining the minimum time, the UE considers that N₁ and N₂ correspond to the smaller of the SCS configurations for the PDSCH and the PUSCH. For μ=0, the UE assumes N_{1,0}=14]. The value of X can be configured or pre-defined), the method proceeds to step 710. Otherwise, the method proceeds to step 716.

At step 710, if the random access preamble transmitted was not selected amongst the contention based preambles (e.g., it is a dedicated preamble assigned by the gNB to the UE), the method proceeds to step 712. Otherwise, the method proceeds to step 714.

At step 712, the UE considers that random access response is successful; the UE considers that RA procedure is successfully completed; the UE processes the TA command received in MAC RAR; the UE discards the UL grant received in MAC RAR; and the UE discards the TC-RNTI received in MAC RAR.

At step 714, (if the random access preamble transmitted was selected amongst the contention based preamble), the UE considers that the random access response is successful; the UE processes the TA command received in the MAC RAR; the UE discards the UL grant received in the MAC RAR; the UE starts to use TC-RNTI; the UE starts the contention resolution timer (even though the UL grant is discarded and the Msg3 is not transmitted) and starts monitoring the PDCCH addressed to the TC-RNTI.

At step 716, (if Scheduling of the RAR PDSCH is not larger than the maximum number of unicast PRBs that the UE can process per slot OR the TDRA for Msg3 to be transmitted in the UL grant in the RAR indicates that the time between the RAR reception and Msg3 transmission is not smaller than NT, 1+NT,2+0.5+X ms), if the random access preamble transmitted was not selected amongst the contention based preambles, the UE considers that the random access response is successful; the UE processes the TA command received in the MAC RAR; the UE starts to use the TC-RNTI; the UE processes the received UL grant in the MAC RAR; the UE transmits the Msg3 in the UL grant and starts the contention resolution timer; and the UE starts monitoring the PDCCH addressed to the TC-RNTI.

At step 718, if the random access preamble transmitted was not selected amongst the contention based preamble, the UE considers that the random access response is successful; the UE considers that the RA procedure is successfully completed; the UE processes the TA command received in the MAC RAR; the UE processes the received UL grant in the MAC RAR; and the UE discards the TC-RNTI received in the MAC RAR.

Although FIG. 7 illustrates one example of a method 700 for RAR/MsgB Handling for an eRedcap UE, various changes may be made to FIG. 7. For example, while shown as a series of steps, various steps in FIG. 7 could overlap, occur in parallel, occur in a different order, occur any number of times, be omitted, or replaced by other steps.

In another embodiment of this disclosure the UE or a MAC entity in the UE initializes/sets to 1 PREAMBLE_TRANSMISSION_COUNTER and PREAMBLE_POWER_RAMPING_COUNTER when a random-access procedure is initiated towards a cell. The UE transmits the MsgA random access preamble to the cell (or to the gNB of the cell) in a random access occasion. The Random access preamble is transmitted on a physical random access channel (PRACH). The UE transmits a MsgA MAC PDU in a PUSCH occasion.

Upon transmitting the MsgA (i.e., random access preamble and MAC PDU), the UE monitors for PDCCH addressed to MSGB-RNTI in random access response window. The UE receives a PDCCH addressed to a MSGB-RNTI which schedules a MSGB PDSCH. The MSGB PDSCH is successfully decoded, and the decoded TB includes a MSGB MAC PDU. The MSGB MAC PDU contains a fallback RAR MAC subPDU with a Random Access Preamble identifier (in the MAC subPDU subheader/header) corresponding to the transmitted random access preamble index and it includes a payload which contains a TA, TC-RNTI and UL grant.

If the MSGB PDSCH is scheduled over a bandwidth larger than the base band bandwidth supported by UE (i.e., larger than the maximum number of unicast PRBs that the UE can process per slot) AND TDRA for Msg3 to be transmitted in UL grant in fallback RAR indicates that the time between MSGB reception and Msg3 transmission is smaller than NT,1+NT,2+0.5+X ms (where N_{T,1} is a time duration of N₁ symbols corresponding to a PDSCH processing time for UE processing capability 1 when additional PDSCH DM-RS is configured, N_{T,2} is a time duration of N₂ symbols corresponding to a PUSCH preparation time for UE processing capability 1 and, for determining the minimum time, the UE considers that N₁ and N₂ correspond to the smaller of the SCS configurations for the PDSCH and the PUSCH. For μ=0, the UE assumes N_{1,0}=14. The value of X can be configured or pre-defined), the UE operation is follows:
If the random access preamble transmitted was not selected amongst the contention based preambles (e.g., it is a dedicated preamble assigned by the gNB to the UE), the UE considers that the random access response is successful; the UE considers that the RA procedure is successfully completed the UE processes the TA command received in fallback RAR; the UE discards the UL grant received in fallback RAR; and the UE discards the TC-RNTI received in fallback RAR.
Otherwise, (if the random access preamble transmitted was selected amongst the contention based preambles), in one embodiment, the UE considers that the random access response reception is unsuccessful; the UE does not process the TA command received in the fallback RAR; the UE discards the UL grant received in fallback RAR, and the UE discards the TC-RNTI received in the fallback RAR. In one embodiment, the UE increments PREAMBLE_TRANSMISSION_COUNTER by 1. If PREAMBLE_TRANSMISSION_COUNTER=preambleTransMax+1, the UE indicates a random access problem to upper layers i.e., RRC. If this random access procedure was triggered for the SI request, the UE considers the random-access procedure unsuccessfully completed. If the random-access procedure is not completed, the UE performs the Random Access Resource selection procedure for 2 step RA and transmits the MsgA random access preamble and MsgA MAC PDU to the cell (or to the gNB of the cell) if PREAMBLE_TRANSMISSION_COUNTER is not equal to msgA-TransMax+1. If PREAMBLE_TRANSMISSION_COUNTER=msgA-TransMax+1, the UE performs the Random-Access Resource selection procedure for 4 step RA and transmits the random-access preamble to the cell (or to the gNB of the cell). If PREAMBLE_TRANSMISSION_COUNTER is greater than one, and if the notification of suspending power ramping counter has not been received from lower layers, and if the LBT failure indication was not received from the lower layers for the last Random Access Preamble transmission, and if the SSB or CSI-RS selected is not changed from the selection in the last Random Access Preamble transmission, the UE increments PREAMBLE_POWER_RAMPING_COUNTER by 1. In one embodiment, the UE may not increment PREAMBLE_TRANSMISSION_COUNTER and the UE may not increment PREAMBLE_POWER_RAMPING_COUNTER. Alternately, the UE may increment PREAMBLE_POWER_RAMPING_COUNTER. The UE may perform the Random Access Resource selection procedure for 2 step RA and transmit the MsgA random access preamble and MsgA MAC PDU to the cell (or to the gNB of the cell). In one embodiment, the UE may ignore/discard the backoff indicator (if any) received in the MSGB. In an alternate embodiment, the UE may store the backoff indicator (if any) received in the MSGB and perform a MSGA transmission after applying the backoff.
In another embodiment, (if the random access preamble transmitted was selected amongst the contention based preambles), the UE ignore/discards the received RAR and continue monitoring RAR window. In an embodiment, UE may ignore/discards the backoff indicator (if any) received in the RAR. In an alternate embodiment, the UE may store the backoff indicator (if any) received in the RAR and perform random access preamble transmission after applying the backoff.
In another embodiment, (if the random access preamble transmitted was selected amongst the contention based preambles), the UE considers that the random access response is successful; the UE processes the TA command received in the MAC RAR; the UE discards the UL grant received in the MAC RAR; the UE starts to use the TC-RNTI; the UE starts the contention resolution timer (even though the UL grant is discarded and the Msg3 is not transmitted) and starts monitoring the PDCCH addressed to the TC-RNTI.

Otherwise, (if Scheduling of MSGB PDSCH is not larger than the maximum number of unicast PRBs that the UE can process per slot OR TDRA for Msg3 to be transmitted in UL grant in fallback RAR indicates that the time between MSGB reception and Msg3 transmission is not smaller than NT,1+NT,2+0.5+X ms), if the random access preamble transmitted was not selected amongst the contention based preambles, the UE considers that the RAR is successful; the UE considers that the RA procedure is successfully completed; the UE processes the TA command received in the fallback RAR the UE processes the received UL grant in the fallback RAR; and the UE discards the TC-RNTI received in the fallback RAR. Otherwise, the UE considers that the RAR is successful; the UE processes the TA command received in the fallback RAR; the UE starts to use the TC-RNTI as C-RNTI; the UE processes the received UL grant in fallback RAR; and the UE Transmits the Msg3 in the UL grant and starts the contention resolution timer.

In one embodiment, if the cell supports the eRedcap UE, upon receiving the random access preamble by the cell, a random access response/MsgB is transmitted via the SpCell (note that cell on which random access preamble is received may be the SpCell or may be the SCell), wherein the gNB schedules RAR/MsgB (PDSCH) within 5 MHz; or the gNB schedules Msg3 such that the time between RAR/MsgB reception and Msg3 transmission is NOT smaller than N_{T,1}+N_{T,2}+0.5+X ms.

In one embodiment, if the cell supports the eRedcap UE, upon receiving the random access preamble by the cell using random access resources configured in cell for the eRedCap UE, a random access response/MsgB is transmitted via the SpCell (note that cell on which random access preamble is received may be the SpCell or may be the SCell), wherein the gNB schedules RAR/MsgB (PDSCH) within 5 MHz; or the gNB schedules Msg3 such that the time between RAR/MsgB reception and Msg3 transmission is NOT smaller than N_{T,1}+N_{T,2}+0.5+X ms.

In one embodiment, if the cell supports the eRedcap UE, upon receiving the random access preamble by the cell using random access resources configured in the cell for the eRedCap UE which supports base band width larger than 5 MHz with more processing delay, a random access response/MsgB is transmitted via the SpCell (note that cell on which random access preamble is received may be the SpCell or may be the SCell), wherein the gNB schedules the RAR/MsgB (PDSCH) within 5 MHz; or the gNB schedules Msg3 such that the time between RAR/MsgB reception and Msg3 transmission is NOT smaller than N_{T,1}+N_{T,2}+0.5+X ms.

In one embodiment, if the cell supports the eRedcap UE, upon receiving the random access preamble by the cell using random access resources configured in cell for the eRedCap UE which supports base band width up to 5 MHz, a random access response/MsgB is transmitted via the SpCell (note that cell on which random access preamble is received may be the SpCell or may be the SCell), wherein the gNB schedules the RAR/MsgB (PDSCH) within 5 MHz; or the gNB schedules Msg3 such that the time between RAR/MsgB reception and Msg3 transmission is NOT smaller than N_{T,1}+N_{T,2}+0.5+X ms.

In one embodiment, multiple sets of RA resources/configurations are configured to the UE for a cell. The network can associate a set of RACH resources/configuration with feature(s) applicable to a random-access procedure, such as Network Slicing, RedCap, SDT, msg3 repetitions, two Msg1 repetitions, 4 Msg1 repetitions, and 8 Msg1 repetitions. In one embodiment, a set of RACH resources (also referred to as RA partition/RA configuration) associated with a feature is only valid for random-access procedures applicable to at least that feature, and a set of RACH resources associated with several features is only valid for random-access procedures having at least all of these features. In one embodiment, the UE selects the set(s) of applicable RACH resources, after uplink carrier (i.e., NUL or SUL) and BWP selection and before selecting the RA type.

In one embodiment, if redCap is set to true for a set of random access resources, the UE considers the set of random access resources as not available for a random-access procedure for which RedCap is not applicable. In one embodiment, if smallData is set to true for a set of random access resources, the UE considers the set of random access resources as not available for the random-access procedure which is not triggered for SDT. In one embodiment, if NSAG-List is configured for a set of random access resources, the UE considers the set of random access resources as not available for the random-access procedure unless it is triggered for any one of the NSAG-ID(s) in the NSAG-List. In one embodiment, if msg3-Repetitions is set to true for a set of random access resources, the UE considers the set of random access resources as not available for the random-access procedure if Msg3 repetition is not applicable. In one embodiment, if a set of random access resources is not configured with FeatureCombination, the UE considers the set of Random Access resources to not associated with any feature. In one embodiment, if twomsg1-Repetitions is set to true (or 2 msg1 repetitions are associated) for a set of random access resources, the UE considers the set of random access resources as not available for the random-access procedure if two Msg1 repetitions is not applicable. In one embodiment, if fourmsg1-Repetitions is set to true (or 4 msg1 repetitions are associated) for a set of random access resource, the UE considers the set of random access resources as not available for the random-access procedure if four Msg1 repetitions is not applicable. In one embodiment, if eightmsg1-Repetitions is set to true (or 8 msg1 repetitions are associated) for a set of random access resources, the UE considers the set of random access resources as not available for the random-access procedure if eight Msg1 repetitions is not applicable.

In one embodiment, the UE receives a PDCCH order or RRCReconfiguration message with reconfiguration with sync IE or RRCReconfiguration message with LTM switching info IE. These include CFRA resources and indicate a number of Msg1 repetitions. Upon initiation of a random-access procedure for these, the UE selects an RA resources/configuration from one or more RA resources/configurations as discussed below herein.

In one embodiment, if the UE is a RedCap UE or eRedCap UE, if one set of RA resources/configuration associated with the redcap feature (redCap is set to true for a set of RA resources/configuration) and the indicated number of msg1 repetitions is available (or if one set of RA resources/configuration associated with only the redcap feature [redCap is set to true for a set of RA resources/configuration] and the indicated number of msg1 repetitions is available, the UE selects that set of RA resources/configuration. Otherwise (i.e. a set of RA resources/configuration associated with the redcap feature and the indicated number of msg1 repetitions is not available (or a set of RA resources/configuration associated with only the redcap feature and the indicated number of msg1 repetitions is not available)), if the set of RA resources/configuration associated with the indicated number of msg1 repetitions is available (or if the set of RA resources/configuration associated with only the indicated number of msg1 repetitions is available), the UE selects that set of RA resources/configuration. Otherwise (i.e. a set of RA resources/configuration associated with the redcap feature and the indicated number of msg1 repetitions is not available (or a set of RA resources/configuration associated with only the redcap feature and the indicated number of msg1 repetitions is not available) AND a set of RA resources/configuration associated with the indicated number of msg1 repetitions is also not available (or a set of RA resources/configuration associated with the only the indicated number of msg1 repetitions is also not available)), the UE selects set of RA resources/configuration which is not associated with any feature (i.e., a set of RA resources/configuration which is not configured with FeatureCombination, FeatureCombination indicates feature(s) associated with a set of RA resources/configuration).

Otherwise, if the UE is not RedCap UE or eRedCap UE, if the set of RA resources/configuration associated with the indicated number of msg1 repetitions is available (of if the set of RA resources/configuration associated with only the indicated number of msg1 repetitions is available), the UE selects that set of RA resources/configuration. Otherwise (i.e. the set of RA resources/configuration associated with the indicated number of msg1 repetitions is not available (of if the set of RA resources/configuration associated with only the indicated number of msg1 repetitions is not available)), the UE selects a set of RA resources/configuration which is not associated with any feature (i.e., a set of RA resources/configuration which is not configured with FeatureCombination, FeatureCombination indicates feature(s) associated with a set of RA resources/configuration).

In one embodiment, if the UE is a RedCap UE or a eRedCap UE, if the set of RA resources/configuration is associated with the redcap feature (redCap is set to true for a set of RA resources/configuration) and the indicated number of msg1 repetitions is available (or if the set of RA resources/configuration is associated with only the redcap feature (redCap is set to true for a set of RA resources/configuration) and the indicated number of msg1 repetitions is available), the UE selects that set of RA resources/configuration. Otherwise (i.e. if the set of RA resources/configuration is associated with ‘the redcap feature and the indicated number of msg1 repetitions’ is not available (or if the set of RA resources/configuration is associated ‘with only the redcap feature and the indicated number of msg1 repetitions’ is not available)), if the set of RA resources/configuration associated with the indicated number of msg1 repetitions is available (or if the set of RA resources/configuration associated with only the indicated number of msg1 repetitions is available), the UE selects that set of RA resources/configuration. Otherwise (i.e. if the set of RA resources/configuration is associated with ‘the redcap feature and the indicated number of msg1 repetitions’ is not available (or if the set of RA resources/configuration is associated ‘with only the redcap feature and the indicated number of msg1 repetitions’ is not available AND if the set of RA resources/configuration associated with the indicated number of msg1 repetitions is not available (or if the set of RA resources/configuration associated with only the indicated number of msg1 repetitions is not available)), if the set of RA resources/configuration associated with redcap feature (redCap is set to true for a set of RA resources/configuration) is available (of if the set of RA resources/configuration associated with only the redcap feature [redCap is set to true for a set of RA resources/configuration] is available), the UE selects that set of RA resources/configuration. Otherwise, the UE selects a set of RA resources/configuration which is not associated with any feature (i.e., set of RA resources/configuration which is not configured with FeatureCombination).

Otherwise, if the UE is not a RedCap UE or eRedCap UE, If the set of RA resources/configuration associated with the indicated number of msg1 repetitions is available (or if the set of RA resources/configuration associated with only the indicated number of msg1 repetitions is available), the UE selects that set of RA resources/configuration. Otherwise (i.e. If the set of RA resources/configuration associated with the indicated number of msg1 repetitions is not available (or if the set of RA resources/configuration associated with only the indicated number of msg1 repetitions is not available)), the UE selects a set of RA resources/configuration which is not associated with any feature (i.e., a set of RA resources/configuration which is not configured with FeatureCombination).

In one embodiment, if the UE is a RedCap UE or eRedCap UE, If the set of RA resources/configuration associated with the redcap feature (redCap is set to true for a set of RA resources/configuration) and the indicated number of msg1 repetitions is available (or if the set of RA resources/configuration associated with only the redcap and the indicated number of msg1 repetitions is available), the UE selects that RA resource configuration. Otherwise (i.e. if the set of RA resources/configuration associated with the redcap feature and the indicated number of msg1 repetitions is not available (or if the set of RA resources/configuration associated with only the redcap and the indicated number of msg1 repetitions is not available)), if the set of RA resources/configuration associated with the redcap feature (redCap is set to true for a set of RA resources/configuration) is available (or if the set of RA resources/configuration associated with only redcap feature [redCap is set to true for a set of RA resources/configuration] is available), the UE selects that set of RA resources/configuration. Otherwise, if the set of RA resources/configuration associated with the indicated number of msg1 repetitions is available (or if the set of RA resources/configuration associated with the indicated number of msg1 repetitions is available), the UE selects that set of RA resources/configuration. Otherwise, the UE selects a set of RA resources/configuration which is not associated with any feature (i.e., a set of RA resources/configuration which is not configured with FeatureCombination).

Otherwise, If the UE is not a RedCap UE or eRedCap UE, if the set of RA resources/configuration associated with the indicated number of msg1 repetitions is available (or if the set of RA resources/configuration associated with the indicated number of msg1 repetitions is available), the UE selects that RA resource configuration. Otherwise, the UE selects a set of RA resources/configuration which is not associated with any feature (i.e., a set of RA resources/configuration which is not configured with FeatureCombination).

In one embodiment, multiple RA resources/configuration are configured to a UE for a cell. The network can associate a set of RACH resources with feature(s) applicable to a random-access procedure, such as Network Slicing, RedCap, SDT, msg3 repetitions, two Msg1 repetitions, 4 Msg1 repetitions, and 8 Msg1 repetitions. In one embodiment, a set of RACH resources (also called as RA partition/RA configuration) associated with a feature is only valid for random-access procedures applicable to at least that feature, and a set of RACH resources associated with several features is only valid for random-access procedures having at least all of these features. In one embodiment, the UE selects the set(s) of applicable RACH resources, after uplink carrier (i.e., NUL or SUL) and BWP selection and before selecting the RA type.

In one embodiment, if redCap is set to true for a set of random access resources, the UE considers the set of random access resources as not available for a random-access procedure for which RedCap is not applicable. In one embodiment, if smallData is set to true for a set of random access resources, the UE considers the set of random access resources as not available for the random-access procedure which is not triggered for SDT. In one embodiment, if NSAG-List is configured for a set of random access resources, the UE considers the set of random access resources as not available for the random-access procedure unless it is triggered for any one of the NSAG-ID(s) in the NSAG-List. In one embodiment if msg3-Repetitions is set to true for a set of random access resources, the UE considers the set of random access resources as not available for the random-access procedure if Msg3 repetition is not applicable. In one embodiment, if a set of random access resources is not configured with FeatureCombination, the UE considers the set of random access resources to not be associated with any feature. In one embodiment, if twomsg1-Repetitions is set to true (or 2 msg1 repetitions are associated) for a set of random access resources, the UE considers the set of random access resources as not available for the random-access procedure if two Msg1 repetitions is not applicable. In one embodiment, if fourmsg1-Repetitions is set to true (or 4 msg1 repetitions are associated) for a set of random access resources, the UE considers the set of random access resources as not available for the random-access procedure if four Msg1 repetitions is not applicable. In one embodiment, if eightmsg1-Repetitions is set to true (or 8 msg1 repetitions are associated) for a set of random access resources, the UE considers the set of random access resources as not available for the random-access procedure if eight Msg1 repetitions is not applicable.

In one embodiment, a random-access procedure is initiated, and the UE selects the UL carrier (SUL or NUL) and UL/DL BWP as described earlier herein. From the selected BWP of the selected UL carrier, the UE selects the set of RA resources/configuration for this random-access procedure as follows:
If the random-access procedure was initiated for an SI request and the Random-Access Resources for the SI request have been explicitly provided by RRC (i.e., SI request resources are received in system information block), the UE selects the set of Random-Access resources that are not associated with any feature indication for the current random-access procedure.
Otherwise, if contention-free random access resources have not been provided for this random-access procedure and one or more of the features including RedCap and/or Slicing and/or SDT and/or MSG3 repetition is applicable for this random-access procedure: if none of the sets of random access resources are available for any feature applicable to the current random-access procedure, the UE selects the set(s) of Random Access resources that are not associated with any feature indication for this random-access procedure. Otherwise, if there is one set of random-access resources available which can be used for indicating all features triggering this random-access procedure, the UE selects this set of random-access resources for this random-access procedure. Otherwise, (i.e., there are one or more sets of random-Access resources available that are configured with indication(s) for a subset of all features triggering this Random-access procedure), the UE selects a set of random-access resources from the available set(s) of random-access resources based on the priority order indicated by upper layers (i.e., RRC) for this random-access procedure.
Otherwise, if contention-free random-access resources have been provided for this random-access procedure and RedCap is applicable for the current random-access procedure and there is one set of random-access resources available that is only configured with RedCap indication, the UE selects this set of random-access resources for this random-access procedure.
Otherwise, the UE selects the set of random-access resources that are not associated with any feature indication for the current random-access procedure.

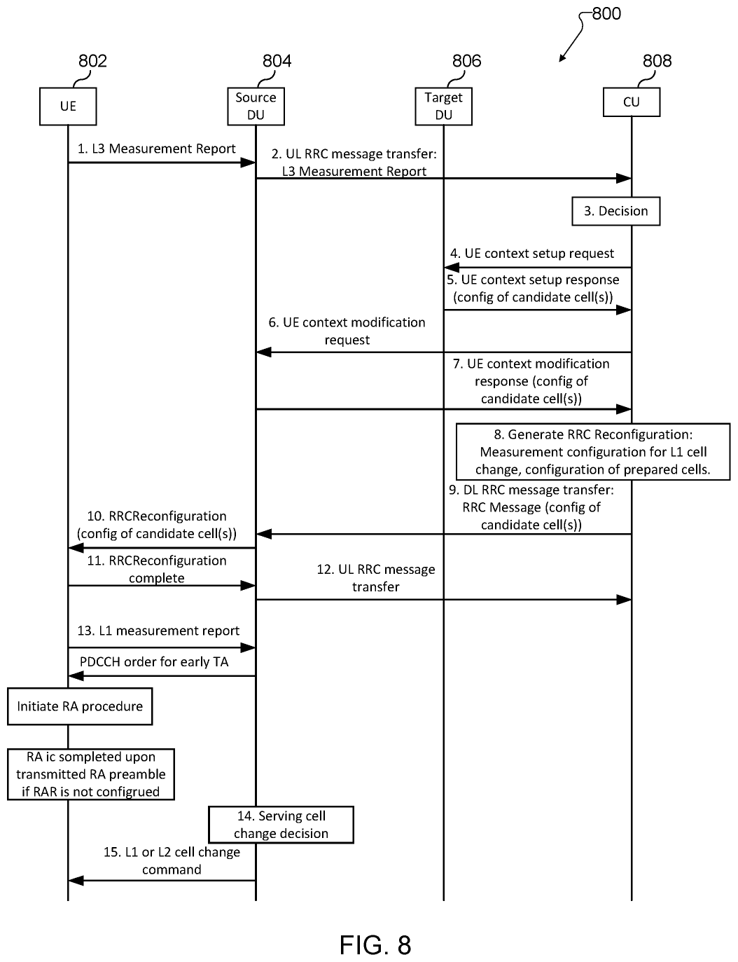

FIG. 8 illustrates a method 800 for random access for early TA according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments for random access for early TA could be used without departing from the scope of this disclosure.

The method 800 begins at step 1. At step 1, a UE 802 transmits a measurement report containing the measurements of serving and target cell(s) to serving cell (i.e., source DU 804). At step 2, serving DU 804 of the serving cell then forwards the report to CU 808. The measurement report can be based on L3 measurements or L1 measurements. Based on the reported measurements, CU 808 may identify a potential set of candidate target cells to which UE 802 can be handed over to in step 3. In this example, CU 808 identifies candidate target cells that are served by either source DU 804 or another DU (i.e., target DU 806) which are controlled by CU 808.

CU 808 requests the preparation of a candidate target cell controlled by target DU 806 by sending a UE Context Setup Request message in step 4. Target DU 806 provides the configuration of UE 802 in a UE Context Setup Response messages, respectively, containing a container from DU 806 to CU 808 in step 5. The configuration may contain UE-specific and non-UE-specific parts. Note that step 4 and step 5 are not performed if candidate target cells of DU 806 are not identified in step 3.

CU 808 requests the preparation of a candidate target cell controlled by source DU 804 by sending a UE Context Modification Request message in step 6. source DU 804 provides the configuration of UE 802 in a UE Context Modification Response message containing a container from DU 804 to CU 808 in step 7. The configuration may contain UE-specific and non-UE-specific parts. Note that step 6 and step 7 are not performed if candidate target cells of DU 804 are not identified in step 3.

Upon receiving the UE configurations for the candidate target cell(s), CU 808 generates an RRC Reconfiguration message (in step 8) including the configuration of candidate target cell(s) for L1 or L2 triggered mobility (LTM) that is sent to UE 802 via DU 804 in step 9 and step 10. The RRC Reconfiguration may include separate RRC Reconfiguration IE for each of candidate target cell(s) or CellGroupConfig IE for each of candidate target cell(s). CU 808 sends the configuration to source DU 804 (step 9) which then sends it to UE 802 (step 10). Among other information, the RRC Reconfiguration message contains: measurement reporting configuration for L1/L2 mobility, i.e., a configuration on how to report the L1 beam measurements of serving and target cells.; configuration of the prepared candidate cell(s) which the UE executes when the UE receives a L1/L2 command to change the serving cell, such as a random access configuration as described earlier, radio bearer configurations, an indication of whether to perform PDCP re-establishment or not (per DRB or common for all), an indication of whether to perform PDCP level data recovery or not (per DRB or common for all), an indication of whether to perform RLC re-establishment or not (per DRB or RLC channel or common for all), an indication of whether to perform MAC reset or partial MAC reset or not, etc. The RRC Reconfiguration may also include firstActiveUplinkBWP and firstActiveDownlinkBWP for each prepared candidate cell(s) and a list of DL and UL BWP configurations for each prepared candidate cell(s). the RRC Reconfiguration may also include InitialUplinkBWP and InitialDownlinkBWP for each prepared candidate cell(s) and a list of DL and UL BWP configurations for each prepared candidate cell(s). In addition to including a separate RRCReconfiguration IE for each of the candidate cells for LTM, the RRCReconfiguration message also includes a RACH configuration for early TA maintenance for one or more candidate cells for LTM. A list of RACH configurations may be included in the RRCReconfiguration message for early TA maintenance wherein each RACH configuration in the list corresponds to a candidate cell (a candidate cell id or PCI is used to identify the corresponding candidate cell). A BWP configuration associated with each RACH configuration for early TA maintenance is also included in the RRCReconfiguration message. Essentially, for each candidate cell for LTM, the RRCReconfiguration message includes an RRCReconfiguration IE (comprising a candidate cell configuration to be used upon switching), a RACH configuration for early TA maintenance (comprising RA configuration/parameters to be applied when RA for early TA is initiated) and a UL (and/or DL) BWP configuration for early TA maintenance (comprising BWP information to be applied when an RA for early TA is initiated). Note that candidate cell configuration for early TA (RACH configuration, BWP configuration etc.) is separate from candidate cell configuration included in the RRCReconfiguration IE. The Candidate cell configuration included in the RRCReconfiguration IE is applied after the cell switch command is received. Candidate cell configuration for early TA is applied before the cell switch command. For each candidate cell (identified by candidate a cell index or physical cell ID or PCI) for LTM, in addition to RRCReconfiguration IE, for early TA for the candidate cell, RRCReconfiguration message includes the following for NUL and/or SUL of the candidate cell: BWP configuration (BWP-UplinkCommon IE which includes subcarrierSpacing; locationAndBandwidth i.e., frequency domain location and bandwidth of this bandwidth part, the first PRB of BWP is a PRB determined by subcarrierSpacing of this BWP and offsetToCarrier; and RACH configuration), absoluteFrequencyPointA i.e., Absolute frequency of the reference resource block (Common RB 0) for the UL carrier, its lowest subcarrier is also known as Point A, offsetToCarrier i.e., the offset in the frequency domain between Point A (lowest subcarrier of common RB 0) and the lowest usable subcarrier on this carrier in number of PRBs (using the subcarrierSpacing defined for this carrier). Essentially, a list of [candidate cell id, BWP configuration and carrier configuration] for early TA may be included in RRCReconfiguration message. In an embodiment, instead of a BWP configuration for early TA, a BWP ID may be included which refers to a BWP amongst the BWP configurations of the candidate cell in the RRCReconfiguration IE of that candidate cell.

In one embodiment, if all candidate cells belongs to the same CU, the CU includes one RRCReconfiguration IE for reference configuration and one RRCReconfiguration IE for each candidate cell configuration. The UE will combine the reference configuration and the candidate cell configuration to determine the complete configuration of the candidate cell.

In one embodiment, if all candidate cells belong to two different CUs, the source CU includes two sets:
The 1^{st} set includes a RRCReconfiguration IE for a reference configuration and one or more RRCReconfiguration IEs for a candidate cell configuration where each RRCReconfiguration IE is for a different candidate cell. For example, if there are three candidate cells belonging to a first CU (e.g., “CU 1”), the 1^{st} set includes a RRCReconfiguration IE for the reference configuration and three more RRCReconfiguration IEs, one for each candidate cell.
The 2^{nd} set includes a RRCReconfiguration IE for reference configuration and one or more RRCReconfiguration IEs for a candidate cell configuration where each RRCReconfiguration IE is for a different candidate cell. For example, if there are two candidate cells belonging to a second CU (e.g., “CU 2”), the 2^{nd} set includes a RRCReconfiguration IE for the reference configuration and two more RRCReconfiguration IEs, one for each candidate cell.
If the first CU (CU 1) is source CU, the first CU will receive RRCReconfiguration IEs for the 2^{nd} set from the second CU (CU 2).
For determining the full configuration of a candidate cell, UE 802 will use a reference configuration from a set in which candidate cell's configuration is included. UE 802 will combine the reference configuration and the candidate cell configuration to determine the complete configuration of the candidate cell.

In one embodiment, multiple sets of configurations where each set includes a reference configuration, and one or more candidate cell configurations is signaled in step 10. Each set may correspond to cells of different CUs.

UE 802 confirms the RRC Reconfiguration to the network in step 11 and step 12.

After confirming the RRC Reconfiguration to the network, UE 802 starts to report the L1 beam measurement of serving and candidate target cells as in step 13. Based on measurements the serving cell may decide to trigger cell change command in step 14. In an example, upon determining that there is a target candidate cell having a better radio link/beam measurement than the serving cell (step 14), e.g., L1-RSRP of target beam measurement>L1-RSRP of serving beam measurement+Offset for a time period (i.e., Time-to-Trigger (TTT) period), the serving cell sends a L1 or L2 cell change/switch command in step 15 to trigger the cell change to the target candidate cell. It is to be noted that RRCReconfiguration may also be sent based on the measurements received in step 13 and later when the condition for cell change is met, the serving cell sends a L1 or L2 cell change/switch command (step 15).

Between step 12 and step 14, the serving cell may send a PDCCH order to UE 802 to perform RA towards a candidate cell (for early TA). In one embodiment UE 802 initiates RA using a RACH configuration configured for early TA of the candidate cell and uses the UL BWP configured for early TA for Msg1/MsgA preamble transmission. This can be repeated for one or more candidate cells received in step 10. In one embodiment, the criteria for random access completion is as follows:
If the random-access procedure is initiated by a PDCCH order for a candidate cell for LTM and a random access response is not configured (configuration [per candidate cell or per cell group or in LTM configuration common for all candidate cells of LTM] indicating whether random access response is configured or not configured can be in the RRC Reconfiguration message step 10 or it can be in a PDCCH order) or supported for this random-access procedure, UE 802 considers this random-access procedure successfully completed upon transmission of a Random Access Preamble, and UE 802 discards any explicitly signaled contention-free Random Access Resources (preambles/ROs etc) for this random-access procedure.
Otherwise, if the random-access procedure is initiated by a PDCCH order for a candidate cell for LTM and random access response is configured (configuration [per candidate cell or per cell group or in LTM configuration common for all candidate cells of LTM] indicating whether random access response is configured or not configured can be in the RRC Reconfiguration message step 10 or it can be in a PDCCH order) or supported for this random-access procedure, if a contention free random access preamble is transmitted by UE 802, UE 802 considers this random-access procedure is successfully completed upon successful reception of a random access response, and if a contention based random access preamble is transmitted by UE 802, UE 802 considers this random-access procedure is successfully completed upon successful contention resolution.

Although FIG. 8 illustrates one example of a method 800 for random access for early TA, various changes may be made to FIG. 8. For example, while shown as a series of steps, various steps in FIG. 8 could overlap, occur in parallel, occur in a different order, occur any number of times, be omitted, or replaced by other steps.

In one embodiment, defaultDownlinkBWP-Id, dormantBWP-Id, initialDownlinkBWP-RedCap, initialDownlinkBWP, defaultDownlinkBWP-Id, bwp-InactivityTimer, initialUplinkBWP-RedCap, initialUplinkBWP are signaled by the gNB and received by the UE in the RRCReconfiguration message.

In one embodiment, the MAC entity in the UE performs the following for each activated serving cell configured with bwp-InactivityTimer:
if the defaultDownlinkBWP-Id is configured, and the active DL BWP is not the BWP indicated by the defaultDownlinkBWP-Id, and the active DL BWP is not the BWP indicated by the dormantBWP-Id if configured; or
if the UE is not a RedCap UE, and if the UE is not an eRedCap UE and if the defaultDownlinkBWP-Id is not configured, and the active DL BWP is not the initialDownlinkBWP, and the active DL BWP is not the BWP indicated by the dormantBWP-Id if configured; or
if the UE is a RedCap UE or if the UE is an eRedCap UE, and if the defaultDownlinkBWP-Id is not configured, and initialDownlinkBWP-RedCap is not configured, and the active DL BWP is not the initialDownlinkBWP; or
if the UE is a RedCap UE or if the UE is an eRedCap UE, and if the defaultDownlinkBWP-Id is not configured, and initialDownlinkBWP-RedCap is configured, and the active DL BWP is not the initialDownlinkBWP-RedCap:
   if a PDCCH addressed to C-RNTI or CS-RNTI indicating downlink assignment or uplink grant is received on the active BWP; or
   if a PDCCH addressed to G-RNTI or G-CS-RNTI configured for multicast indicating downlink assignment is received on the active BWP; or
   if a PDCCH addressed to C-RNTI or CS-RNTI indicating downlink assignment or uplink grant is received for the active BWP; or
   if a MAC PDU is transmitted in a configured uplink grant and LBT failure indication is not received from lower layers; or
   if a MAC PDU is received in a configured downlink assignment for unicast or MBS multicast:
      if there is no ongoing random-access procedure associated with this Serving Cell; or
      if the ongoing random-access procedure associated with this Serving Cell is successfully completed upon reception of this PDCCH addressed to C-RNTI:
         the MAC entity starts or restarts the bwp-InactivityTimer associated with the active DL BWP.
   if the bwp-Inactivity Timer associated with the active DL BWP expires:
      if the defaultDownlinkBWP-Id is configured:
         the MAC entity performs BWP switching to a BWP indicated by the defaultDownlinkBWP-Id.
      otherwise
         if the UE is a RedCap UE or if the UE is an eRedCap UE; and
         if initialDownlinkBWP-RedCap is configured:
         the MAC entity performs BWP switching to the initialDownlinkBWP-RedCap.
         otherwise
         the MAC entity performs BWP switching to the initialDownlinkBWP.

NOTE: If a random-access procedure is initiated on an SCell, both this SCell and the SpCell are associated with this random-access procedure.
if a PDCCH for BWP switching is received, and the MAC entity switches the active DL BWP:
   if the defaultDownlinkBWP-Id is configured, and the MAC entity switches to the DL BWP which is not indicated by the defaultDownlinkBWP-Id and is not indicated by the dormantBWP-Id if configured; or
   if the UE is not a RedCap UE or if the UE is not an eRedCap UE, and if the defaultDownlinkBWP-Id is not configured, and the MAC entity switches to the DL BWP which is not the initialDownlinkBWP and is not indicated by the dormantBWP-Id if configured; or
   if the UE is a RedCap UE or if the UE is an eRedCap UE, and if the defaultDownlinkBWP-Id is not configured, and initialDownlinkBWP-RedCap is not configured, and the MAC entity switches to the DL BWP which is not the initialDownlinkBWP; or
   if the UE is a RedCap UE or if the UE is an eRedCap UE, and if the defaultDownlinkBWP-Id is not configured, and initialDownlinkBWP-RedCap is configured, and the MAC entity switches to the DL BWP which is not the initialDownlinkBWP-RedCap:
      the MAC entity starts or restarts the bwp-InactivityTimer associated with the active DL BWP.

In one embodiment, upon initiation of the random-access procedure, after selection of the carrier for performing the random-access procedure, if the UE is a RedCap UE or if the UE is an eRedCap UE in RRC_IDLE or RRC_INACTIVE mode, the MAC entity in the UE performs the following:
if initialUplinkBWP-RedCap is configured for the selected carrier:
   the MAC entity performs the random-access procedure by using the BWP configured by initialUplinkBWP-RedCap.
otherwise:
   the MAC entity performs the random-access procedure by using the BWP configured by initialUplinkBWP.
if initialDownlinkBWP-RedCap is configured:
   if the random-access procedure was initiated for an SI request and the Random Access Resources for the SI request have been explicitly provided by RRC, and if the selected carrier is the SUL carrier:
      the MAC entity monitors the PDCCH on the BWP configured by initialDownlinkBWP.
   otherwise:
      the MAC entity monitors the PDCCH on the BWP configured by initialDownlinkBWP-RedCap.
otherwise:
   the MAC entity monitors the PDCCH on the BWP configured by initialDownlinkBWP.

In one embodiment, the UE receives a PDCCH addressed to an RA-RNTI which schedules a PDSCH for a RAR. The PDSCH for the RAR is successfully decoded and the received transport block (TB) includes a RAR MAC PDU. The RAR MAC PDU contains a MAC subPDU with a Random Access Preamble identifier (in the MAC subPDU subheader/header) corresponding to the index/identifier of the transmitted random access preamble and this MAC subPDU is not a RAPID only MAC subPDU (i.e., it includes a payload which contains TA, TC-RNTI and UL grant). This MAC subPDU is also referred as MAC RAR.

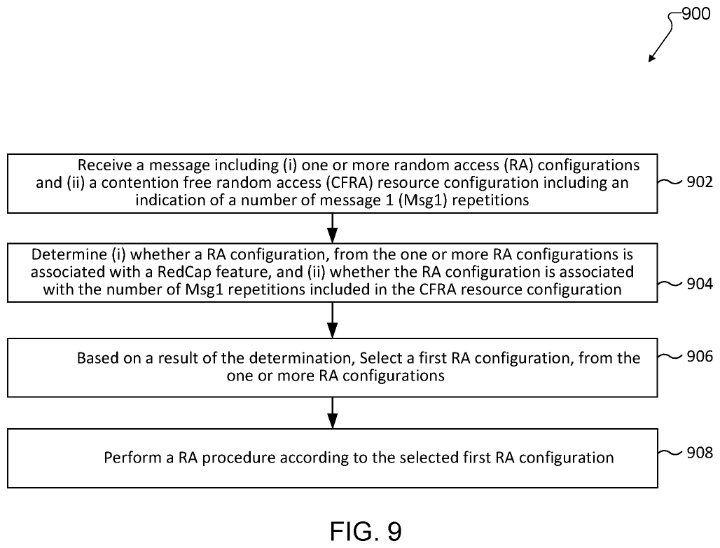

FIG. 9 illustrates a method 900 for random access for enhanced reduced capability user equipments according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for random access for enhanced reduced capability user equipments could be used without departing from the scope of this disclosure.

In the example of FIG. 9, method 900 begins at step 902. At step 902, a UE receives a message including (i) one or more random access (RA) configurations and (ii) a contention free random access (CFRA) resource configuration including an indication of a number of message 1 (Msg1) repetitions. At step 904, the UE determines (i) whether a RA configuration, from the one or more RA configurations is associated with a RedCap feature, and (ii) whether the RA configuration is associated with the number of Msg1 repetitions included in the CFRA resource configuration. At step 906, based on a result of the determination, the UE selects a first RA configuration, from the one or more RA configurations. Finally, at step 908, the UE performs a RA procedure according to the selected first RA configuration.

Although FIG. 9 illustrates one example of a method 900 for random access for enhanced reduced capability user equipments, various changes may be made to FIG. 9. For example, while shown as a series of steps, various steps in FIG. 9 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A reduced capability (RedCap) user equipment (UE) comprising:
a transceiver configured to receive a message including (i) one or more random access (RA) configurations and (ii) a contention free random access (CFRA) resource configuration including an indication of a number of message 1 (Msg1) repetitions; and
a processor operatively coupled to the transceiver, the processor configured to:
determine (i) whether a RA configuration, from the one or more RA configurations is associated with a RedCap feature, and (ii) whether the RA configuration is associated with the number of Msg1 repetitions included in the CFRA resource configuration;
based on a result of the determination, select a first RA configuration, from the one or more RA configurations, and
perform a RA procedure according to the selected first RA configuration.

2. The RedCap UE of claim 1, wherein:
when (i) the RA configuration is associated with the RedCap feature and (ii) the RA configuration is associated with the number of Msg1 repetitions included in the CFRA resource configuration, the first RA configuration is associated with the RedCap feature and the number of Msg1 repetitions included in the CFRA resource configuration.

3. The RedCap UE of claim 1, wherein:
when (i) the RA configuration is associated with RedCap feature and (ii) there is no RA configuration associated with the RedCap feature and the number of Msg1 repetitions included in the CFRA resource configuration, the first RA configuration is associated with the RedCap feature.

4. The RedCap UE of claim 1, wherein:
when (i) there is no RA configuration associated with Redcap feature and (ii) there is no RA configuration associated with the Redcap feature and the number of Msg1 repetitions included in the CFRA resource configuration and (iii) the RA configuration is associated with the number of Msg1 repetitions included in the CFRA resource configuration, the first RA configuration is associated with the number of Msg1 repetitions included in the CFRA resource configuration.

5. The RedCap UE of claim 1, wherein:
when (i) there is no RA configuration associated with RedCap feature and (ii) there is no RA configuration associated with the RedCap feature and the number of Msg1 repetitions included in the CFRA resource configuration and (iii) there is no RA configuration associated with the number of Msg1 repetitions included in the CFRA resource configuration, the first RA configuration is not associated with any feature.

6. The RedCap UE of claim 1, wherein:
the transceiver is further configured to:
receive a random access response (RAR) during the RA procedure, wherein a bandwidth of a physical downlink shared channel (PDSCH) of the RAR is larger than a bandwidth the RedCap UE can process per slot; and
receive a RAR including an uplink (UL) grant for transmission of a message 3 (Msg3); and
the processor is further configured to determine whether a time interval between the reception of the RAR and the transmission of the Msg3 in the UL grant is less than a threshold.

7. The RedCap UE of claim 6, wherein the processor is further configured to consider that the reception of the RAR is unsuccessful if a determination is made that the time interval between the reception of the RAR and the transmission of the Msg3 in the UL grant is less than the threshold.

8. A base station (BS) comprising:
a transceiver configured to transmit a message including (i) one or more random access (RA) configurations and (ii) a contention free random access (CFRA) resource configuration including an indication of a number of message 1 (Msg1) repetitions; and
a processor operatively coupled to the transceiver, the processor configured to perform a RA procedure with a reduced capability (RedCap) user equipment (UE),
wherein the RA procedure is performed according to a first RA configuration from the one or more RA configurations selected by the RedCap UE.

9. The BS of claim 8, wherein the first RA configuration is associated with a RedCap feature and the number of Msg1 repetitions included in the CFRA resource configuration.

10. The BS of claim 8, wherein the first RA configuration is associated with a RedCap feature.

11. The BS of claim 8, wherein the first RA configuration is associated with the number of Msg1 repetitions included in the CFRA resource configuration.

12. The BS of claim 8, wherein the first RA configuration is not associated with any feature.

13. The BS of claim 8, wherein the transceiver is further configured to:
transmit a random access response (RAR) during the RA procedure, wherein a bandwidth of a physical downlink shared channel (PDSCH) of the RAR is larger than a bandwidth the RedCap UE can process per slot; and
transmit a RAR including an uplink (UL) grant for transmission of a message 3 (Msg3).

14. A method of operating a reduced capability (RedCap) user equipment (UE), the method comprising:
receiving a message including (i) one or more random access (RA) configurations and (ii) a contention free random access (CFRA) resource configuration including an indication of a number of message 1 (Msg1) repetitions;
determining (i) whether a RA configuration, from the one or more RA configurations is associated with a RedCap feature, and (ii) whether the RA configuration is associated with the number of Msg1 repetitions included in the CFRA resource configuration;
based on a result of the determination, selecting a first RA configuration, from the one or more RA configurations; and
performing a RA procedure according to the selected first RA configuration.

15. The method of claim 14, wherein:
when (i) the RA configuration is associated with the RedCap feature and (ii) the RA configuration is associated with the number of Msg1 repetitions is included in the CFRA resource configuration, the first RA configuration is associated with the RedCap feature and the number of Msg1 repetitions included in the CFRA resource configuration.

16. The method of claim 14, wherein:
when (i) the RA configuration is associated with RedCap feature and (ii) there is no RA configuration associated with the RedCap feature and the number of Msg1 repetitions included in the CFRA resource configuration, the first RA configuration is associated with the RedCap feature.

17. The method of claim 14, wherein:
when (i) there is no RA configuration associated with Redcap feature and (ii) there is no RA configuration associated with the Redcap feature and the number of Msg1 repetitions included in the CFRA resource configuration and (iii) the RA configuration is associated with the number of Msg1 repetitions included in the CFRA resource configuration, the first RA configuration is associated with the number of Msg1 repetitions included in the CFRA resource configuration.

18. The method of claim 14, wherein:
when (i) there is no RA configuration associated with RedCap feature and (ii) there is no RA configuration associated with the RedCap feature and the number of Msg1 repetitions included in the CFRA resource configuration and (iii) there is no RA configuration associated with the number of Msg1 repetitions included in the CFRA resource configuration, the first RA configuration is not associated with any feature.

19. The method of claim 14, further comprising:
receiving a random access response (RAR) during the RA procedure, wherein a bandwidth of a physical downlink shared channel (PDSCH) of the RAR is larger than a bandwidth the RedCap UE can process per slot;
receiving a RAR including an uplink (UL) grant for transmission of a message 3 (Msg3); and
determining whether a time interval between the reception of the RAR and the transmission of the Msg3 in the UL grant is less than a threshold.

20. The method of claim 19, wherein the reception of the RAR is unsuccessful if a determination is made that the time interval between the reception of the RAR and the transmission of the Msg3 in the UL grant is less than the threshold.
